(19) United States
(12) Patent Application Publication
(10) Pub. No.: US 2025/0019481 A1
(43) Pub. Date: Jan. 16, 2025

(54) THERMOPLASTIC MODACRYLIC RESIN AND THERMOPLASTIC MODACRYLIC RESIN COMPOSITION INCLUDING SAME

(71) Applicant: KANEKA CORPORATION, Osaka (JP)

(72) Inventors: Sota Okumura, Hyogo (JP); Takamasa Soejima, Osaka (JP)

(73) Assignee: KANEKA CORPORATION, Osaka (JP)

(21) Appl. No.: 18/897,202

(22) Filed: Sep. 26, 2024

Related U.S. Application Data
(63) Continuation of application No. PCT/JP2023/012687, filed on Mar. 28, 2023.

(30) Foreign Application Priority Data
Mar. 31, 2022 (JP) 2022-059820

(51) Int. Cl. C08F 290/04; C08K 3/34; C08K 5/07; C08K 5/098; C08K 5/41; C08K 13/02; C08L 51/00; D01D 5/084; D01F 6/40

(52) U.S. Cl. CPC C08F 290/046; C08K 13/02; C08L 51/003; D01D 5/084; D01F 6/40; C08K 3/346; C08K 5/07; C08K 5/098; C08K 5/41; C08K 2201/014; C08L 2201/08; C08L 2203/12; D10B 2321/101

(57) ABSTRACT

A thermoplastic modacrylic resin suitable for producing modacrylic fiber excellent in strength and/or melt spinning stability is provided. The thermoplastic modacrylic resin includes a copolymer. The copolymer includes a polymer (A) that includes a modacrylic resin containing constituent unit 1 derived from acrylonitrile (a1) and constituent unit 2 derived from an ethylenically unsaturated monomer (a2) other than the acrylonitrile (a1), and a polymer (B) that contains constituent unit 3 derived from acrylonitrile (b1). The polymer (B) has first and second terminals and is bound to the polymer (A) at the second terminal. The polymer (B) has 30 mol % or more to less than 70 mol % of all constituent unit 3 in a terminal region that contains the first terminal and contains one-half of all constituent units in the polymer (B). The constituent unit 3 content is 3 to 50 mol % relative to all constituent units in the polymer (B).

### TECHNICAL FIELD

One or more embodiments of the present invention relate to a thermoplastic modacrylic resin that contains a copolymer of a polymer formed of a modacrylic resin and a polymer containing a constituent unit derived from acrylonitrile and a constituent unit derived from an ethylenically unsaturated monomer other than the acrylonitrile, and a thermoplastic modacrylic resin composition containing the thermoplastic modacrylic resin.

### BACKGROUND

A modacrylic fiber, which is formed of a modacrylic resin obtained by copolymerizing acrylonitrile and a vinyl halide or the like, has been used in various products such as artificial hair, a flame-retardant material, and a pile fabric. In the related art, a decomposition start temperature of the modacrylic resin is lower than a softening temperature thereof, and the modacrylic resin is decomposed by melt processing, and thus the modacrylic resin has been fiberized by a wet spinning method. However, in the case of the wet spinning method, a drainage load is high and recovery cost of a solvent is high.

Therefore, it is disclosed in Patent Document 1 that it is possible to produce a modacrylic fiber by a melt spinning method by using a graft copolymer obtained by grafting a modacrylic resin, which is obtained by copolymerizing acrylonitrile and an ethylenically unsaturated monomer other than the acrylonitrile, with a macromonomer containing an ethylenically unsaturated monomer.

### PATENT DOCUMENT

Patent Document 1: PCT International Publication No. WO2019/187404

Since the modacrylic fiber can be produced by the melt spinning method, the melt spinning method is required to be functionally differentiated from a processing method in the related art such as the wet spinning method, and further, the modacrylic resin is required to be applied in various melt processing methods. For example, in order to achieve differentiation in functions or to widen a processing application possibility, a modacrylic fiber excellent in either or both of strength and stability for melt spinning is required.

### SUMMARY

One or more embodiments of the present invention have been made in view of the above to provide a thermoplastic modacrylic resin suitable for producing a modacrylic fiber excellent in either or both of strength and stability for melt spinning.

As a result of diligently repeated research for solving the above, the inventors have found that properties such as improvement of either or both of strength and stability for melt spinning, which is not observed for a thermoplastic modacrylic resin in the related art, can be imparted by randomly introducing a predetermined amount of a constituent unit derived from acrylonitrile into a macromonomer in a thermoplastic modacrylic resin containing a copolymer, and setting a content of a specific monomer containing the macromonomer within a predetermined range in the thermoplastic modacrylic resin, thereby completing one or more embodiments of the present invention.

A first aspect of one or more embodiments of the present invention is a thermoplastic modacrylic resin containing a copolymer, in which the copolymer contains a polymer (A) formed of a modacrylic resin containing a constituent unit derived from acrylonitrile (a1) and a constituent unit derived from an ethylenically unsaturated monomer (a2) other than the acrylonitrile (a1), and a polymer (B) composed of a polymer containing a constituent unit derived from acrylonitrile (b1) and a constituent unit derived from an ethylenically unsaturated monomer (b2) other than the acrylonitrile (b1), the polymer (B) has a first terminal and a second terminal, and is bonded to the polymer (A) at the second terminal, the polymer (B) contains more than 30 mol % and less than 70 mol % of all constituent units derived from the acrylonitrile (b1) in a terminal region including the first terminal and including half of the number of all constituent units in the polymer (B), a content of the constituent unit derived from the acrylonitrile (b1) is 3 mol % or more and 50 mol % or less with respect to all the constituent units in the polymer (B), and in the thermoplastic modacrylic resin, a content of the constituent unit derived from the acrylonitrile (a1) is 35 mass % or more and 84.5 mass % or less, a content of the constituent unit derived from the ethylenically unsaturated monomer (a2) is 15 mass % or more and 64.5 mass % or less, and a content of the polymer (B) is 0.5 mass % or more and 40 mass % or less.

A second aspect of one or more embodiments of the present invention is a thermoplastic modacrylic resin composition that contains the thermoplastic modacrylic resin and a plasticizer, in which the plasticizer is an organic compound having compatibility with the thermoplastic modacrylic resin and has a boiling point of 200° C. or higher.

A third aspect of one or more embodiments of the present invention is a molded product formed of the thermoplastic modacrylic resin composition.

A fourth aspect of one or more embodiments of the present invention is a modacrylic fiber formed of the thermoplastic modacrylic resin composition.

A fifth aspect of one or more embodiments of the present invention is a method for producing a modacrylic fiber that includes melt-spinning the thermoplastic modacrylic resin composition to obtain a modacrylic fiber.

According to one or more embodiments of the present invention, it is possible to provide a thermoplastic modacrylic resin that is excellent in either or both of strength and stability for melt spinning. It is possible to suitably produce a modacrylic fiber excellent in either or both of strength and stability for melt spinning by using the thermoplastic modacrylic resin according to one or more embodiments of the present invention. The modacrylic fiber can be stably melt-spun while effectively preventing yarn breakage in a case in which the modacrylic fiber is excellent in stability for melt spinning. In this case, as a result, it is possible to obtain a modacrylic fiber having a finer fineness. In a case in which the thermoplastic modacrylic resin according to one or more embodiments of the present invention is excellent in stability for melt spinning, it is presumed that the stability for melt spinning is caused by excellent fluidity of the thermoplastic modacrylic resin.

### DETAILED DESCRIPTION

A thermoplastic modacrylic resin according to one or more embodiments of the present invention may be referred to as a random type thermoplastic modacrylic resin. A copolymer constituting the random type thermoplastic modacrylic resin may be referred to as a random type copolymer. Hereinafter, the thermoplastic modacrylic resin and the copolymer will be described.

### Random Type Thermoplastic Modacrylic Resin

The random type thermoplastic modacrylic resin contains the random type copolymer that contains a polymer (A) formed of a modacrylic resin containing a constituent unit derived from acrylonitrile (a1) and a constituent unit derived from an ethylenically unsaturated monomer (a2) other than the acrylonitrile (a1), and a polymer (B) composed of a polymer containing a constituent unit derived from acrylonitrile (b1) and a constituent unit derived from an ethylenically unsaturated monomer (b2) other than the acrylonitrile (b1).

### Polymer (B)

The polymer (B) has a first terminal and a second terminal, and is bonded to the polymer (A) at the second terminal. The first terminal is a free end present at a position farthest from the polymer (A) in the polymer (B). The polymer (B) has a terminal region including the first terminal and a region other than the terminal region (hereinafter, also referred to as a “non-terminal region”). The polymer (B) contains more than 30 mol % and less than 70 mol % of all constituent units derived from the acrylonitrile (b1) in the terminal region including the first terminal and including half of the number of all constituent units in the polymer (B). On the other hand, the polymer (B) also contains more than 30 mol % and less than 70 mol % of all the constituent units derived from the acrylonitrile (b1) in the non-terminal region. Accordingly, a large deviation is less likely to occur in the distribution of the constituent unit derived from the acrylonitrile (b1) between the terminal region and the non-terminal region, and the constituent unit derived from the acrylonitrile (b1) is likely to be present at a density within a predetermined range over the entire polymer (B). In the present description, such a structure is referred to as a “random type structure”. On the other hand, in a case in which a polymer (B′), which has a first terminal and a second terminal and is bonded to the polymer (A) at the second terminal in a manner similar to the polymer (B), contains 70 mol % or more of all constituent units derived from the acrylonitrile (b1) in a terminal region including the first terminal and including half of the number of all constituent units in the polymer (B′), such a structure is referred to as an “α-block type structure” in the present description. Further, in a case in which a polymer (B″), which has a first terminal and a second terminal and is bonded to the polymer (A) at the second terminal in a manner similar to the polymer (B), contains 70 mol % or more of all constituent units derived from the acrylonitrile (b1) in a non-terminal region including the second terminal and including half of the number of all constituent units in the polymer (B″), such a structure is referred to as an “ω-block type structure” in the present description.

The polymer (B) may contain more than 30 mol % and less than 70 mol %, 35 mol % or more and 65 mol % or less, or 40 mol % or more and 60 mol % or less, or 45 mol % or more and 55 mol % or less of all the constituent units derived from the acrylonitrile (b1) in the terminal region from the viewpoint of either or both of high strength and high stability for melt spinning.

The ratio of the constituent unit derived from the acrylonitrile (b1) in the terminal region may be 10% to 100%, or 15% to 100% with respect to the number of all the constituent units in the terminal region from the viewpoint of either or both of high strength and high stability for melt spinning. In a case in which the ratio of the constituent unit derived from the acrylonitrile (b1) in the terminal region is less than 100%, the constituent unit derived from the ethylenically unsaturated monomer (b2) is included in the terminal region. The ratio (b1/b2) of the constituent unit derived from the acrylonitrile (b1) to the constituent unit derived from the ethylenically unsaturated monomer (b2) in the terminal region may be 10/90 or more and 100/0 or less, or 15/85 or more and 100/0 or less.

As the ethylenically unsaturated monomer (b2) that is a constituent material of the polymer (B) having the random type structure, at least one selected from the group consisting of a (meth)acrylic acid, a (meth)acrylate-based monomer, a styrene-based monomer, a nitrile group-containing vinyl monomer, and an amide group-containing vinyl monomer is preferable. In the present description, the (meth)acrylic acid means an acrylic acid and/or a methacrylic acid.

Examples of the (meth)acrylate-based monomer include a (meth)acrylic acid aliphatic hydrocarbon ester containing an aliphatic hydrocarbon group having 1 to 18 carbon atoms, a (meth)acrylic acid alicyclic hydrocarbon ester, a (meth)acrylic acid aromatic hydrocarbon ester, and a (meth)acrylic acid aralkyl ester.

Examples of the (meth)acrylic acid aliphatic hydrocarbon ester containing an aliphatic hydrocarbon group having 1 to 18 carbon atoms include a methyl (meth)acrylate, an ethyl (meth)acrylate, an n-propyl (meth)acrylate, an isopropyl (meth)acrylate, an n-butyl (meth)acrylate, an isobutyl (meth)acrylate, a tert-butyl (meth)acrylate, an n-pentyl (meth)acrylate, an n-hexyl (meth)acrylate, an n-heptyl (meth)acrylate, an n-octyl (meth)acrylate, a 2-ethylhexyl (meth)acrylate, a nonyl (meth)acrylate, a decyl (meth)acrylate, a dodecyl (meth)acrylate, and a stearyl (meth)acrylate. Examples of the (meth)acrylic acid alicyclic hydrocarbon ester include a cyclohexyl (meth)acrylate and an isobornyl (meth)acrylate. Examples of the (meth)acrylic acid aromatic hydrocarbon ester include a phenyl (meth)acrylate and a toluyl (meth)acrylate. Examples of the (meth)acrylic acid aralkyl ester include a benzyl (meth)acrylate.

Further, for example, a (meth)acrylate-based monomer having a heteroatom in an ester moiety may be used as the (meth)acrylate-based monomer. The heteroatom is not particularly limited, and examples thereof include oxygen (O), fluorine (F), and nitrogen (N). Examples of the (meth)acrylate-based monomer having a heteroatom in the ester moiety include a 2-methoxyethyl (meth)acrylate, a 3-methoxybutyl (meth)acrylate, a 2-hydroxyethyl (meth)acrylate, a 2-hydroxypropyl (meth)acrylate, a glycidyl (meth)acrylate, a 2-aminoethyl (meth)acrylate, γ-(methacryloyloxypropyl) trimethoxysilane, an ethylene oxide adduct of the (meth)acrylic acid, a trifluoromethyl methyl (meth)acrylate, a 2-trifluoromethyl ethyl (meth)acrylate, a 2-perfluoroethyl ethyl (meth)acrylate, a 2-perfluoroethyl-2-perfluorobutyl ethyl (meth)acrylate, a 2-perfluoroethyl (meth)acrylate, a perfluoromethyl (meth)acrylate, a diperfluoromethyl methyl (meth)acrylate, a 2-perfluoromethyl-2-perfluoroethyl methyl (meth)acrylate, a 2-perfluorohexyl ethyl (meth)acrylate, a 2-perfluorodecyl ethyl (meth)acrylate, and a 2-perfluorohexadecyl ethyl (meth)acrylate.

Examples of the styrene-based monomer include styrene, vinyl toluene, α-methylstyrene, chlorostyrene, styrene sulfonic acid, and salts thereof.

Examples of a nitrile group-containing vinyl monomer include a monomer other than the acrylonitrile, such as methacrylonitrile.

Examples of an amide group-containing vinyl monomer include an acrylamide and a methacrylamide.

The number of the constituent units of the polymer (B) may be 10 or more and 400 or less, or 15 or more and 150 or less from the viewpoint of either or both of high strength and high stability for melt spinning.

A content of the constituent unit derived from the acrylonitrile (b1) in the polymer (B) may be 3 mol % or more and 50 mol % or less, 4 mol % or more and 45 mol % or less, or 4.5 mol % or more and 42.5 mol % or less of all the constituent units in the polymer (B) from the viewpoint of either or both of high strength and high stability for melt spinning. The molar content ratio (b1/b2) of the constituent unit derived from the acrylonitrile (b1) to the constituent unit derived from the ethylenically unsaturated monomer (b2) in the polymer (B) may be 0.1/99.9 or more and 20/80 or less, or 1/99 or more and 15/85 or less.

A number average molecular weight (Mn) of the polymer (B) may be 1000 or more and 50000 or less, or 2000 or more and 20000 or less from the viewpoint of either or both of high strength and high stability for melt spinning. Regarding the polymer (B), the ratio (Mw/Mn) of a weight average molecular weight Mw to the number average molecular weight Mn may be 1.1 or more and 1.5 or less from the viewpoint of narrow molecular weight distribution.

### Polymer (A)

As described above, the polymer (A) is formed of the modacrylic resin containing the constituent unit derived from the acrylonitrile (a1) and the constituent unit derived from the ethylenically unsaturated monomer (a2).

As the ethylenically unsaturated monomer (a2) that is a constituent material of the polymer (A), at least one selected from the group consisting of a vinyl halide, a vinylidene halide, and vinyl acetate is preferable.

Examples of the vinyl halide include a vinyl chloride, a vinyl bromide, and a vinyl iodide. These may be used alone or may be used in combination of two or more thereof.

Examples of the vinylidene halide include a vinylidene chloride, a vinylidene bromide, and a vinylidene iodide. These may be used alone or may be used in combination of two or more thereof.

A content of the constituent unit derived from the acrylonitrile (a1) is 35 mass % or more and 84.5 mass % or less, or 35 mass % or more and 64 mass % or less with respect to the entire random type thermoplastic modacrylic resin from the viewpoint of either or both of high strength and high stability for melt spinning. A content of the constituent unit derived from the ethylenically unsaturated monomer (a2) may be 15 mass % or more and 64.5 mass % or less, or 30 mass % or more and 70 mass % or less with respect to the entire random type thermoplastic modacrylic resin from the viewpoint of either or both of high strength and high stability for melt spinning. A content of the polymer (B) may be 0.5 mass % or more and 40 mass % or less, or 1 mass % or more and 30 mass % or less with respect to the entire random type thermoplastic modacrylic resin from the viewpoint of either or both of high strength and high stability for melt spinning.

A weight average molecular weight (Mw) of the random type thermoplastic modacrylic resin may be 10000 or more and 300000 or less, or 20000 or more and 150000 or less from the viewpoint of either or both of high strength and high stability for melt spinning.

### Method for Producing Thermoplastic Modacrylic Resin

The random type thermoplastic modacrylic resin can be produced by, for example, copolymerizing the acrylonitrile (a1) and the ethylenically unsaturated monomer (a2) that are used to prepare the modacrylic resin forming the polymer (A), and a macromonomer constituting the polymer (B) to obtain the random type copolymer.

The macromonomer means an oligomer molecule having a reactive functional group in a terminal of a polymer. The macromonomer constituting the polymer (B) may have, as the reactive functional group, at least one polymerizable carbon-carbon double bond-containing group per molecule at a terminal of a copolymer containing the constituent unit derived from the acrylonitrile (b1) and the constituent unit derived from the ethylenically unsaturated monomer (b2), and the polymerizable carbon-carbon double bond-containing group is selected from, for example, the group consisting of an allyl group, a vinylsilyl group, a vinyl ether group, a dicyclopentadienyl group, and a group containing a polymerizable carbon-carbon double bond represented by the following general formula (1). The macromonomer can be usually produced by radical polymerization. In particular, the reactivity with the acrylonitrile (a1) and the ethylenically unsaturated monomer (a2) is excellent, and thus in the macromonomer, the reactive functional group may contain the polymerizable carbon-carbon double bond represented by the following general formula (1).

CH₂═C(R)—C(O)O— (1)
wherein, R represents a hydrogen atom or an organic group having 1 to 20 carbon atoms. For example, specific examples of R may include a group selected from the group consisting of —H, —CH₃, —CH₂CH₃, —(CH₂)ₙCH₃ (n represents an integer of 2 to 19), —C₆H₅, —CH₂OH, and —CN, or may include a group selected from the group consisting of —H and —CH₃.

The copolymer, which is a main chain of the macromonomer, containing the constituent unit derived from the acrylonitrile (b1) and the constituent unit derived from the ethylenically unsaturated monomer (b2) is produced by a radical polymerization method. The radical polymerization method can be classified into a “general radical polymerization method” in which a monomer having a specific functional group and a vinyl-based monomer are simply copolymerized by using an azo-based compound, a peroxide, or the like as a polymerization initiator, and a “controllable radical polymerization method” in which a specific functional group can be introduced into a controlled position such as a terminal.

A method for producing the copolymer, which is a macromonomer used in one or more embodiments of the present invention, containing the constituent unit derived from the acrylonitrile (b1) and the constituent unit derived from the ethylenically unsaturated monomer (b2) is not particularly limited, and a producing method known in the related art can be used. For example, methods for producing the macromonomer are described in JP2006-299240A, any one of these producing methods may be used, a controllable radical polymerization method is generally used, a living radical polymerization method may be further used from the viewpoint of ease of control, and an atom transfer radical polymerization method is particularly preferable.

In a case in which the macromonomer used for the random type thermoplastic modacrylic resin is produced by the atom transfer radical polymerization method, for example, the macromonomer can be produced by preparing a random copolymer using the acrylonitrile (b1) and the ethylenically unsaturated monomer (b2), and then introducing a reactive functional group into a terminal of the obtained polymer.

As a method for producing the random type thermoplastic modacrylic resin, suspension polymerization or fine suspension polymerization is preferable from the viewpoint of simplicity of polymerization and relaxation of polymerization heat generation.

### Thermoplastic Modacrylic Resin Composition

In one or more embodiments of the present invention, it is possible to blend a plasticizer, which has compatibility with the random type thermoplastic modacrylic resin containing the random type copolymer, with the thermoplastic modacrylic resin and use the obtained mixture as a thermoplastic modacrylic resin composition.

The plasticizer is not particularly limited as long as the plasticizer is an organic compound having compatibility with the thermoplastic modacrylic resin and having a boiling point of 200° C. or higher. For example, sulfone-based compounds such as dimethyl sulfone, diethyl sulfone, dipropyl sulfone, dibutyl sulfone, diphenyl sulfone, vinyl sulfone, ethyl methyl sulfone, methyl phenyl sulfone, methyl vinyl sulfone, and 3-methylsulfolane; sulfoxide-based compounds such as dipropyl sulfoxide, tetramethylene sulfoxide, diisopropyl sulfoxide, methyl phenyl sulfoxide, dibutyl sulfoxide, diisobutyl sulfoxide, di-p-tolyl sulfoxide, diphenyl sulfoxide, and benzyl sulfoxide; lactides such as lactic acid lactide; lactams such as pyrrolidone, N-methylpyrrolidone, N-vinylpyrrolidone, ε-caprolactam, and N-methylcaprolactam; lactones such as γ-butyrolactone, γ-hexalactone, γ-heptalactone, γ-octalactone, ε-caprolactone, and ε-octalactone can be used. Further, the plasticizer may be used alone or may be used in combination of two or more thereof.

When fibers are held at a temperature higher than a melting point of the plasticizer, the plasticizer may be changed into a liquid and seep out to a fiber surface, and thus external appearance and touch feeling of the fibers become poor, and then, when the temperature returns to room temperature (25±5° C.), the plasticizer is changed into a solid, and sticking between the fibers easily occurs. In particular, an indoor temperature may rise to 60° C. in an inboard container at the time of overseas transport, and the indoor temperature may reach 90° C. for a short time at the time of fiber processing, and thus the melting point of the plasticizer for the thermoplastic modacrylic resin may be 60° C. or higher, or 90° C. or higher. For example, at least one selected from the group consisting of dimethyl sulfone, lactic acid lactide, and ε-caprolactam may be used, and at least one selected from the group consisting of dimethyl sulfone and lactic acid lactide may be or used.

In the thermoplastic modacrylic resin composition, a content of the plasticizer is 0.1 parts by mass or more and 50 parts by mass or less with respect to 100 parts by mass of the thermoplastic modacrylic resin from the viewpoint of melt processability. When the content of the plasticizer is 0.1 parts by mass or more and 50 parts by mass or less, the melt processability is good, and a resin viscosity at the time of melt-kneading is improved, and thus kneading efficiency tends to be improved.

The thermoplastic modacrylic resin composition may further contain a stabilizer for thermal stability. The stabilizer is not particularly limited as long as the stabilizer imparts the thermal stability. From the viewpoint of preventing coloring and ensuring transparency while improving the melt processability, the stabilizer may be at least one stabilizer selected from the group consisting of an epoxy-based heat stabilizer, a hydrotalcite-based heat stabilizer, a tin-based heat stabilizer, a Ca—Zn-based heat stabilizer, and a β-diketone-based heat stabilizer. Specific examples of the stabilizer include polyglycidyl methacrylate, tetrabromobisphenol A diglycidyl ether, hydrotalcite, zinc 12-hydroxystearate, calcium 12-hydroxystearate, stearoyl benzoyl methane (SBM), and dibenzoyl methane (DBM). The stabilizer may be used alone or may be used in combination of two or more thereof.

In the thermoplastic modacrylic resin composition, a content of the stabilizer may be 0.1 parts by mass or more and 30 parts by mass or less, 0.2 parts by mass or more and 20 parts by mass or less, or 0.5 parts by mass or more and 10 parts by mass or less with respect to 100 parts by mass of the thermoplastic modacrylic resin. When the content is 0.1 parts by mass or more, the effect of preventing the coloring is good. Further, when the content is 30 parts by mass or less, the effect of preventing the coloring is good, the transparency can be ensured, and deterioration in mechanical characteristics of a modacrylic resin-molded product is slight.

The thermoplastic modacrylic resin composition may contain a lubricant in a range in which the purpose of one or more embodiments of the present invention is not impaired from the viewpoint of reducing heat generation due to friction and shear between the thermoplastic modacrylic resin and a processing machine and improving fluidity and releasability. As the lubricant, for example, fatty acid ester-based lubricants such as a monoglyceride stearate and a stearyl stearate, hydrocarbon-based lubricants such as a liquid paraffin, a paraffin wax, and a synthetic polyethylene wax, fatty acid-based lubricants such as stearic acid, higher alcohol-based lubricants such as stearyl alcohol, aliphatic amide-based lubricants such as stearamide, oleamide, and erucamide, alkylene fatty acid amide-based lubricants such as methylene bis(stearamide) and ethylene bis(stearamide), and metal soap-based lubricants such as a lead stearate, a zinc stearate, a calcium stearate, and a magnesium stearate can be used. These may be used alone or may be used in combination of two or more thereof. An addition amount of the lubricant may be 10 parts by mass or less with respect to 100 parts by mass of the thermoplastic modacrylic resin.

The thermoplastic modacrylic resin composition may contain a processing aid such as a modacrylic processing aid in a range in which the thermoplastic modacrylic resin suitable for producing a modacrylic fiber excellent in either or both of strength and stability for melt spinning is not impaired. When the fibers are formed of the thermoplastic modacrylic resin composition, a (meth)acrylate-based polymer and/or a styrene-acrylonitrile copolymer may be contained as the processing aid from the viewpoint of increasing spinnability. As the (meth)acrylate-based polymer, a copolymer of a (meth)acrylate and a copolymer component such as a butyl (meth)acrylate, an isobutyl (meth)acrylate, a 2-ethylhexyl (meth)acrylate, styrene, vinyl acetate, and acrylonitrile can be used. In addition, as the (meth)acrylate-based polymer, a commercially available product such as “Kane Ace PA20” and “Kane Ace PA101” manufactured by Kaneka Corporation can be used. An addition amount of the processing aid can be 10 parts by mass or less with respect to 100 parts by mass of the thermoplastic modacrylic resin.

The thermoplastic modacrylic resin composition can be used in a molten state, that is, can be used as a molten material. The molten material can be obtained by melt-kneading the thermoplastic modacrylic resin composition. A method for the melt-kneading is not particularly limited, and a general method for melt-kneading a resin composition can be used.

A molded product can be obtained by processing the thermoplastic modacrylic resin composition obtained above into a predetermined shape. A molded product according to the present disclosure refers to the molded product formed of the thermoplastic modacrylic resin composition. A molding method is not particularly limited, and examples thereof include an extrusion molding method, an injection molding method, an insert molding method, a sandwich molding method, a foam molding method, a press molding method, a blow molding method, a calendar molding method, a rotational molding method, a slash molding method, a dip molding method, and a cast molding method. Examples of the molded product include a film, a plate, a fiber, an extrusion-molded product, and an injection-molded product. The molded product may be a foam, and may be porous. In the present disclosure, the “film” refers to a film that has a thin film shape having a thickness of 200 μm or less and has flexibility, and the “plate” refers to a plate that has a thin film shape having a thickness exceeding 200 μm or a plate shape and has no flexibility.

Modacrylic fibers can be formed of the thermoplastic modacrylic resin composition. Modacrylic fibers according to the present disclosure refer to the modacrylic fibers containing the thermoplastic modacrylic resin composition. Specifically, the modacrylic fibers can be obtained by melt-spinning the thermoplastic modacrylic resin composition (for example, the pellet-shaped thermoplastic modacrylic resin composition after the melt-kneading). First, the thermoplastic modacrylic resin composition is melt-spun into fibrous undrawn yarns. Specifically, a melt-kneaded material (the pellet-shaped thermoplastic modacrylic resin composition) of the thermoplastic modacrylic resin composition, which is melt-kneaded by an extruder such as a single-screw extruder, a different-direction twin-screw extruder, and a conical twin-screw extruder, is discharged from a spinning nozzle in the extruder and is passed through a heating cylinder, a fiberized material of the thermoplastic modacrylic resin composition is heated to a temperature equal to or higher than a temperature at which the fiberized material can be taken along by a take-up machine, and then the fiberized material is taken along while being cooled to a temperature equal to or lower than a glass transition temperature by means such as air cooling and wind cooling to form the undrawn yarns. The extruder may operate in a temperature range of 120° C. or higher and 200° C. or lower, for example. The ratio of a take-up speed/a discharging speed is not particularly limited, and for example, it is preferable to take along the fiberized material at a speed ratio in a range of 1 time or more and 100 times or less, and a range of 5 times or more and 50 times or less is further preferable from the viewpoint of spinning stability. A diameter of the spinning nozzle is not particularly limited, and for example, the diameter may be 0.05 mm or more and 2 mm or less, or 0.1 mm or more and 1 mm or less. A discharged material from the spinning nozzle may be extruded at a temperature equal to or higher than a nozzle temperature at which no melt fracture appears. A temperature of the spinning nozzle may be 160° C. or higher, or 170° C. or higher. A temperature of the heating cylinder may be 200° C. or higher, or 230° C. or higher. A cooling temperature may be −196° C. or higher and 40° C. or lower, or 0° C. or higher and 30° C. or lower for air cooling, and may be 5° C. or higher and 60° C. or lower, or 10° C. or higher and 40° C. or lower for water cooling.

The undrawn yarns obtained above can be subjected to a drawing process and, if necessary, a heat relaxation process by known methods. For example, when the undrawn yarns are used as artificial hair, the undrawn yarns may be produced to fibers having a single fiber fineness of 2 dtex or more and 100 dtex or less. As a condition of the drawing process, a draw ratio may be about 1.1 times or more and 6 times or less, or about 1.5 times or more and 4.5 times or less in a dry heat atmosphere in which a temperature of the drawing process is 70° C. or higher and 150° C. or lower. By performing the heat relaxation process on the fibers subjected to the drawing process and performing a relaxation process on the fibers at a relaxation ratio of 1% or more and 50% or less, or 5% or more and 40% or less, a heat shrinkage ratio can be reduced. Further, the heat relaxation process is also preferable in order to adjust an uneven surface of the fibers and provide a smooth feeling similar to human hair. Further, fineness control can also be performed by washing the undrawn yarns or drawn yarns with water. In one or more embodiments of the present invention, the single fiber fineness is measured based on JIS L 1013.

### EXAMPLES

Hereinafter, one or more embodiments of the present invention will be described in more detail based on examples and comparative examples, and one or more embodiments of the present invention is not limited to the following examples.

First, various measurement methods and evaluation methods will be described.

### (1) Weight Average Molecular Weight and Number Average Molecular Weight

The weight average molecular weight and the number average molecular weight were measured and calculated by gel permeation chromatography (“HLC-8320GPC” manufactured by Tosoh Corporation).

### (2) Specific Viscosity ηsp

1.0 g of the copolymer was dissolved in 500 ml of dimethylformamide and a specific viscosity ηsp was measured by using an Ostwald viscometer at 30° C.

### (3) Fineness and Strength

A fineness and a strength of the modacrylic fibers were measured based on JIS L 1015.

### (4) Spinning Time at 150 dtex and Spinning Time at 100 dtex

When undrawn yarn fibers of 150 dtex or 100 dtex were obtained by discharging the undrawn yarns from a circular spinning nozzle having 12 holes and taking along the undrawn yarns at 10 times or more and 14 times or less nozzle draft according to a melt spinning procedure of the modacrylic fibers to be described later, a time during which the yarns discharged from the 12 holes could be wound without yarn breakage, that is, a time from the start of the winding to occurrence of the yarn breakage was measured, and an average time of the measurement performed three times was defined as a spinning time. Hereinafter, a spinning time obtained for the undrawn yarn fibers of 150 dtex is referred to as a “spinning time at 150 dtex”, and a spinning time obtained for the undrawn yarn fibers of 100 dtex is referred to as a “spinning time at 100 dtex”.

### (5) Minimum Fineness

When the spinning time was obtained by changing the fineness of the undrawn yarn fibers in the same manner as in the above (4), a smallest fineness at which a spinning time of 15 seconds could be achieved is referred to as a minimum fineness.

### Production of Macromonomer

### Production Example 1

1.7 parts by mass of acrylonitrile, 38.3 parts by mass of 2-methoxyethyl acrylate, 12 parts by mass of methanol (MeOH), 3.54 parts by mass of ethyl 2-bromobutyrate, and 0.18 parts by mass of triethylamine were added to a reaction vessel, and the added raw materials were stirred at 40° C. in a nitrogen atmosphere. Next, 0.0203 parts by mass of copper (II) bromide (CuBr₂) was dissolved in 8 parts by mass of methanol, the obtained mixture was added to 0.0209 parts by mass of hexamethyl tris(2-aminoethyl)amine (Me₆TREN), the obtained mixture was then added to a reaction system, and the raw materials in the reaction system were mixed. Further, 0.799 parts by mass of ascorbic acid and 0.918 parts by mass of triethylamine were adjusted by 14.3 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 68% (total monomer consumption of 27%) after 70 minutes from the start of dropping of the ascorbic acid solution, 2.6 parts by mass of acrylonitrile and 57.4 parts by mass of 2-methoxyethyl acrylate were added dropwise to the reaction system over 75 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 97% after 240 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 1.

100 parts by mass of the one-terminal-Br group-containing polymer 1 was added to a flask and was diluted with 100 parts by mass of dimethylacetamide, 3.9 parts by mass of potassium acrylate was added thereto, and the mixture was heated and stirred at 70° C. for 3 hours. Thereafter, the dimethylacetamide was distilled off from the reaction mixture, the reaction mixture was dissolved in the toluene and was passed through the activated alumina column, and then the toluene was distilled off to obtain a one-terminal-acryloyl group-containing macromonomer 1 in which a constituent unit derived from the acrylonitrile is uniformly introduced. A number average molecular weight of the obtained one-terminal-acryloyl group-containing macromonomer 1 was 6000, and a molecular weight distribution (a weight average molecular weight/the number average molecular weight) thereof was 1.2. The one-terminal-acryloyl group-containing macromonomer 1 contained 51 mol % of all constituent units derived from the acrylonitrile in a terminal region including a terminal on a side opposite to a terminal of an acryloyl group and including half of the number of all constituent units in the one-terminal-acryloyl group-containing macromonomer 1.

### Production Example 2

2.7 parts by mass of acrylonitrile, 37.3 parts by mass of 2-methoxyethyl acrylate, 12 parts by mass of methanol (MeOH), 3.66 parts by mass of ethyl 2-bromobutyrate, and 0.19 parts by mass of triethylamine were added to a reaction vessel, and the added raw materials were stirred at 40° C. in a nitrogen atmosphere. Next, 0.0209 parts by mass of copper (II) bromide (CuBr₂) was dissolved in 8 parts by mass of methanol, the obtained mixture was added to 0.0216 parts by mass of hexamethyl tris(2-aminoethyl)amine (Me₆TREN), the obtained mixture was then added to a reaction system, and the raw materials in the reaction system were mixed. Further, 0.825 parts by mass of ascorbic acid and 0.948 parts by mass of triethylamine were adjusted by 14.7 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 11% (total monomer consumption of 4%) after 30 minutes from the start of dropping of the ascorbic acid solution, 4.0 parts by mass of acrylonitrile and 56.0 parts by mass of 2-methoxyethyl acrylate were added dropwise to the reaction system over 120 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 93% after 210 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 2.

The obtained one-terminal-Br group-containing polymer 2 was converted to a one-terminal acryloyl group in the same manner as Production Example 1, and a one-terminal-acryloyl group-containing macromonomer 2 in which a constituent unit derived from the acrylonitrile was uniformly introduced was obtained. A number average molecular weight of the obtained one-terminal-acryloyl group-containing macromonomer 2 was 6000, and a molecular weight distribution (a weight average molecular weight/the number average molecular weight) thereof was 1.2. The one-terminal-acryloyl group-containing macromonomer 2 contained 51 mol % of all constituent units derived from the acrylonitrile in a terminal region including a terminal on a side opposite to the terminal of the acryloyl group and including half of the number of all constituent units in the one-terminal-acryloyl group-containing macromonomer 2.

### Production Example 3

3.7 parts by mass of acrylonitrile, 36.3 parts by mass of 2-methoxyethyl acrylate, 12 parts by mass of methanol (MeOH), 3.78 parts by mass of ethyl 2-bromobutyrate, and 0.18 parts by mass of triethylamine were added to a reaction vessel, and the added raw materials were stirred at 40° C. in a nitrogen atmosphere. Next, 0.0216 parts by mass of copper (II) bromide (CuBr₂) was dissolved in 8 parts by mass of methanol, the obtained mixture was added to 0.0223 parts by mass of hexamethyl tris(2-aminoethyl)amine (Me₆TREN), the obtained mixture was then added to a reaction system, and the raw materials in the reaction system were mixed. Further, 0.853 parts by mass of ascorbic acid and 0.980 parts by mass of triethylamine were adjusted by 15.2 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 44% (total monomer consumption of 18%) after 70 minutes from the start of dropping of the ascorbic acid solution, 5.6 parts by mass of acrylonitrile and 54.4 parts by mass of 2-methoxyethyl acrylate were added dropwise to the reaction system over 75 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 95% after 310 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 3.

The obtained one-terminal-Br group-containing polymer 3 was converted to a one-terminal acryloyl group in the same manner as Production Example 1, and a one-terminal-acryloyl group-containing macromonomer 3 in which a constituent unit derived from the acrylonitrile was uniformly introduced was obtained. A number average molecular weight of the obtained one-terminal-acryloyl group-containing macromonomer 3 was 6000, and a molecular weight distribution (a weight average molecular weight/the number average molecular weight) thereof was 1.2. The one-terminal-acryloyl group-containing macromonomer 3 contained 52 mol % of all constituent units derived from the acrylonitrile in a terminal region including a terminal on a side opposite to the terminal of the acryloyl group and including half of the number of all constituent units in the one-terminal-acryloyl group-containing macromonomer 3.

### Production Example 4

5.9 parts by mass of acrylonitrile, 34.1 parts by mass of 2-methoxyethyl acrylate, 12 parts by mass of methanol (MeOH), 4.05 parts by mass of ethyl 2-bromobutyrate, and 0.18 parts by mass of triethylamine were added to a reaction vessel, and the added raw materials were stirred at 40° C. in a nitrogen atmosphere. Next, 0.0232 parts by mass of copper (II) bromide (CuBr₂) was dissolved in 8 parts by mass of methanol, the obtained mixture was added to 0.0239 parts by mass of hexamethyl tris(2-aminoethyl)amine (Me₆TREN), the obtained mixture was then added to a reaction system, and the raw materials in the reaction system were mixed. Further, 0.914 parts by mass of ascorbic acid and 1.051 parts by mass of triethylamine were adjusted by 16.3 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 12% (total monomer consumption of 5%) after 70 minutes from the start of dropping of the ascorbic acid solution, 8.9 parts by mass of acrylonitrile and 51.1 parts by mass of 2-methoxyethyl acrylate were added dropwise to the reaction system over 75 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 95% after 320 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 4.

The obtained one-terminal-Br group-containing polymer 4 was converted to a one-terminal acryloyl group in the same manner as Production Example 1, and a one-terminal-acryloyl group-containing macromonomer 4 in which a constituent unit derived from the acrylonitrile was uniformly introduced was obtained. A number average molecular weight of the obtained one-terminal-acryloyl group-containing macromonomer 4 was 6000, and a molecular weight distribution (a weight average molecular weight/the number average molecular weight) thereof was 1.2. The one-terminal-acryloyl group-containing macromonomer 4 contained 53 mol % of all constituent units derived from the acrylonitrile in a terminal region including a terminal on a side opposite to the terminal of the acryloyl group and including half of the number of all constituent units in the one-terminal-acryloyl group-containing macromonomer 4.

### Production Example 5

8.5 parts by mass of acrylonitrile, 31.5 parts by mass of 2-methoxyethyl acrylate, 12 parts by mass of methanol (MeOH), 4.36 parts by mass of ethyl 2-bromobutyrate, and 0.18 parts by mass of triethylamine were added to a reaction vessel, and the added raw materials were stirred at 40° C. in a nitrogen atmosphere. Next, 0.0250 parts by mass of copper (II) bromide (CuBr₂) was dissolved in 8 parts by mass of methanol, the obtained mixture was added to 0.0258 parts by mass of hexamethyl tris(2-aminoethyl)amine (Me₆TREN), the obtained mixture was then added to a reaction system, and the raw materials in the reaction system were mixed. Further, 0.985 parts by mass of ascorbic acid and 1.132 parts by mass of triethylamine were adjusted by 17.6 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 25% (total monomer consumption of 10%) after 70 minutes from the start of dropping of the ascorbic acid solution, 12.8 parts by mass of acrylonitrile and 47.2 parts by mass of 2-methoxyethyl acrylate were added dropwise to the reaction system over 75 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 95% after 310 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 5.

The obtained one-terminal-Br group-containing polymer 5 was converted to a one-terminal acryloyl group in the same manner as Production Example 1, and a one-terminal-acryloyl group-containing macromonomer 5 in which a constituent unit derived from the acrylonitrile was uniformly introduced was obtained. A number average molecular weight of the obtained one-terminal-acryloyl group-containing macromonomer 5 was 6000, and a molecular weight distribution (a weight average molecular weight/the number average molecular weight) thereof was 1.2. The one-terminal-acryloyl group-containing macromonomer 5 contained 53 mol % of all constituent units derived from the acrylonitrile in a terminal region including a terminal on a side opposite to the terminal of the acryloyl group and including half of the number of all constituent units in the one-terminal-acryloyl group-containing macromonomer 5.

### Production Example 6

0.8 parts by mass of acrylonitrile, 39.2 parts by mass of 2-methoxyethyl acrylate, 12 parts by mass of methanol (MeOH), 3.43 parts by mass of ethyl 2-bromobutyrate, and 0.18 parts by mass of triethylamine were added to a reaction vessel, and the added raw materials were stirred at 40° C. in a nitrogen atmosphere. Next, 0.0197 parts by mass of copper (II) bromide (CuBr₂) was dissolved in 8 parts by mass of methanol, the obtained mixture was added to 0.0203 parts by mass of hexamethyl tris(2-aminoethyl)amine (Me₆TREN), the obtained mixture was then added to a reaction system, and the raw materials in the reaction system were mixed. Further, 0.031 parts by mass of ascorbic acid and 0.036 parts by mass of triethylamine were adjusted by 3.0 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 3% (total monomer consumption of 8%) after 70 minutes from the start of dropping of the ascorbic acid solution, 1.3 parts by mass of acrylonitrile and 58.7 parts by mass of 2-methoxyethyl acrylate were added dropwise to the reaction system over 75 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 95% after 310 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 6.

The obtained one-terminal-Br group-containing polymer 6 was converted to a one-terminal acryloyl group in the same manner as Production Example 1, and a one-terminal-acryloyl group-containing macromonomer 6 in which a constituent unit derived from the acrylonitrile was uniformly introduced was obtained. A number average molecular weight of the obtained one-terminal-acryloyl group-containing macromonomer 6 was 6000, and a molecular weight distribution (a weight average molecular weight/the number average molecular weight) thereof was 1.2. The one-terminal-acryloyl group-containing macromonomer 6 contained 51 mol % of all constituent units derived from the acrylonitrile in a terminal region including a terminal on a side opposite to the terminal of the acryloyl group and including half of the number of all constituent units in the one-terminal-acryloyl group-containing macromonomer 6.

### Production Example 7

1.7 parts by mass of acrylonitrile, 38.3 parts by mass of 2-methoxyethyl acrylate, 12 parts by mass of methanol (MeOH), 3.54 parts by mass of ethyl 2-bromobutyrate, and 0.18 parts by mass of triethylamine were added to a reaction vessel, and the added raw materials were stirred at 40° C. in a nitrogen atmosphere. Next, 0.0203 parts by mass of copper (II) bromide (CuBr₂) was dissolved in 8 parts by mass of methanol, the obtained mixture was added to 0.0209 parts by mass of hexamethyl tris(2-aminoethyl)amine (Me₆TREN), the obtained mixture was then added to a reaction system, and the raw materials in the reaction system were mixed. Further, 0.799 parts by mass of ascorbic acid and 0.918 parts by mass of triethylamine were adjusted by 14.3 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 68% (total monomer consumption of 27%) after 70 minutes from the start of dropping of the ascorbic acid solution, 2.6 parts by mass of acrylonitrile and 57.4 parts by mass of 2-methoxyethyl acrylate were added dropwise to the reaction system over 75 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 97% after 240 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 7.

The obtained one-terminal-Br group-containing polymer 7 was converted to a one-terminal acryloyl group in the same manner as Production Example 1, and a one-terminal-acryloyl group-containing macromonomer 7 in which a constituent unit derived from the acrylonitrile was uniformly introduced was obtained. A number average molecular weight of the obtained one-terminal-acryloyl group-containing macromonomer 7 was 6000, and a molecular weight distribution (a weight average molecular weight/the number average molecular weight) thereof was 1.2. The one-terminal-acryloyl group-containing macromonomer 7 contained 51 mol % of all constituent units derived from the acrylonitrile in a terminal region including a terminal on a side opposite to the terminal of the acryloyl group and including half of the number of all constituent units in the one-terminal-acryloyl group-containing macromonomer 7.

### Production Example 8

3.7 parts by mass of acrylonitrile, 36.3 parts by mass of 2-methoxyethyl acrylate, 12 parts by mass of methanol (MeOH), 3.78 parts by mass of ethyl 2-bromobutyrate, and 0.18 parts by mass of triethylamine were added to a reaction vessel, and the added raw materials were stirred at 40° C. in a nitrogen atmosphere. Next, 0.0216 parts by mass of copper (II) bromide (CuBr₂) was dissolved in 8 parts by mass of methanol, the obtained mixture was added to 0.0223 parts by mass of hexamethyl tris(2-aminoethyl)amine (Me₆TREN), the obtained mixture was then added to a reaction system, and the raw materials in the reaction system were mixed. Further, 0.853 parts by mass of ascorbic acid and 0.980 parts by mass of triethylamine were adjusted by 15.2 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 44% (total monomer consumption of 18%) after 70 minutes from the start of dropping of the ascorbic acid solution, 5.6 parts by mass of acrylonitrile and 54.4 parts by mass of 2-methoxyethyl acrylate were added dropwise to the reaction system over 75 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 95% after 310 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 8.

The obtained one-terminal-Br group-containing polymer 8 was converted to a one-terminal acryloyl group in the same manner as Production Example 1, and a one-terminal-acryloyl group-containing macromonomer 8 in which a constituent unit derived from the acrylonitrile was uniformly introduced was obtained. A number average molecular weight of the obtained one-terminal-acryloyl group-containing macromonomer 8 was 6000, and a molecular weight distribution (a weight average molecular weight/the number average molecular weight) thereof was 1.2. The one-terminal-acryloyl group-containing macromonomer 8 contained 52 mol % of all constituent units derived from the acrylonitrile in a terminal region including a terminal on a side opposite to the terminal of the acryloyl group and including half of the number of all constituent units in the one-terminal-acryloyl group-containing macromonomer 8.

### Production Example 9

3.0 parts by mass of acrylonitrile, 46.0 parts by mass of 2-methoxyethyl acrylate, 12 parts by mass of methanol (MeOH), 3.54 parts by mass of ethyl 2-bromobutyrate, and 0.18 parts by mass of triethylamine were added to a reaction vessel, and the added raw materials were stirred at 40° C. in a nitrogen atmosphere. Next, 0.0203 parts by mass of copper (II) bromide (CuBr₂) was dissolved in 8 parts by mass of methanol, the obtained mixture was added to 0.0209 parts by mass of hexamethyl tris(2-aminoethyl)amine (Me₆TREN), the obtained mixture was then added to a reaction system, and the raw materials in the reaction system were mixed. Further, 0.799 parts by mass of ascorbic acid and 0.918 parts by mass of triethylamine were adjusted by 14.3 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 87% (total monomer consumption of 42%) after 120 minutes from the start of dropping of the ascorbic acid solution, 1.3 parts by mass of acrylonitrile and 49.7 parts by mass of 2-methoxyethyl acrylate were added dropwise to the reaction system over 70 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 98% after 240 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 9.

The obtained one-terminal-Br group-containing polymer 9 was converted to a one-terminal acryloyl group in the same manner as Production Example 1, and a one-terminal-acryloyl group-containing macromonomer 9 containing a large number of constituent units derived from the acrylonitrile on a side opposite to the terminal of the acryloyl group was obtained. A number average molecular weight of the obtained one-terminal-acryloyl group-containing macromonomer 9 was 6000, and a molecular weight distribution (a weight average molecular weight/the number average molecular weight) thereof was 1.2. The one-terminal-acryloyl group-containing macromonomer 9 contained 67 mol % of all constituent units derived from the acrylonitrile in a terminal region including a terminal on the side opposite to the terminal of the acryloyl group and including half of the number of all constituent units in the one-terminal-acryloyl group-containing macromonomer 9.

### Production Example 10

1.5 parts by mass of acrylonitrile, 48.8 parts by mass of 2-methoxyethyl acrylate, 12 parts by mass of methanol (MeOH), 3.54 parts by mass of ethyl 2-bromobutyrate, and 0.18 parts by mass of triethylamine were added to a reaction vessel, and the added raw materials were stirred at 40° C. in a nitrogen atmosphere. Next, 0.0203 parts by mass of copper (II) bromide (CuBr₂) was dissolved in 8 parts by mass of methanol, the obtained mixture was added to 0.0209 parts by mass of hexamethyl tris(2-aminoethyl)amine (Me₆TREN), the obtained mixture was then added to a reaction system, and the raw materials in the reaction system were mixed. Further, 0.799 parts by mass of ascorbic acid and 0.918 parts by mass of triethylamine were adjusted by 14.3 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 89% (total monomer consumption of 45%) after 150 minutes from the start of dropping of the ascorbic acid solution, 2.8 parts by mass of acrylonitrile and 46.9 parts by mass of 2-methoxyethyl acrylate were added dropwise to the reaction system over 60 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 97% after 310 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 10.

The obtained one-terminal-Br group-containing polymer 10 was converted to a one-terminal acryloyl group in the same manner as Production Example 1, and a one-terminal-acryloyl group-containing macromonomer 10 containing a large number of constituent units derived from the acrylonitrile on a side of the terminal of the acryloyl group was obtained. A number average molecular weight of the obtained one-terminal-acryloyl group-containing macromonomer 10 was 6000, and a molecular weight distribution (a weight average molecular weight/the number average molecular weight) thereof was 1.2. The one-terminal-acryloyl group-containing macromonomer 10 contained 65 mol % of all the constituent units derived from the acrylonitrile in a non-terminal region including the terminal of the acryloyl group and including half of the number of all constituent units in the one-terminal-acryloyl group-containing macromonomer 10.

### Production Example 11

40 parts by mass of 2-methoxyethyl acrylate, 12 parts by mass of methanol (MeOH), 3.33 parts by mass of ethyl 2-bromobutyrate, and 0.18 parts by mass of triethylamine were added to a reaction vessel, and the added raw materials were stirred at 40° C. in a nitrogen atmosphere. Next, 0.0191 parts by mass of copper (II) bromide (CuBr₂) was dissolved in 8 parts by mass of methanol, the obtained mixture was added to 0.0197 parts by mass of hexamethyl tris(2-aminoethyl)amine (Me₆ TREN), the obtained mixture was then added to a reaction system, and the raw materials in the reaction system were mixed. Further, 0.015 parts by mass of ascorbic acid and 0.017 parts by mass of triethylamine were adjusted by 3.0 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 37% (total monomer consumption of 15%) after 60 minutes from the start of dropping of the ascorbic acid solution, 60 parts by mass of 2-methoxyethyl acrylate was added dropwise to the reaction system over 60 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 95% after 310 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 11.

The obtained one-terminal-Br group-containing polymer 11 was converted to a one-terminal acryloyl group in the same manner as Production Example 1, and a one-terminal-acryloyl group-containing macromonomer 11 not containing a constituent unit derived from the acrylonitrile was obtained. A number average molecular weight of the obtained one-terminal-acryloyl group-containing macromonomer 11 was 6000, and a molecular weight distribution (a weight average molecular weight/the number average molecular weight) thereof was 1.2.

### Production Example 12

4.3 parts by mass of acrylonitrile, 15.7 parts by mass of 2-methoxyethyl acrylate, 12 parts by mass of methanol (MeOH), 3.54 parts by mass of ethyl 2-bromobutyrate, and 0.18 parts by mass of triethylamine were added to a reaction vessel, and the added raw materials were stirred at 40° C. in a nitrogen atmosphere. Next, 0.0203 parts by mass of copper (II) bromide (CuBr₂) was dissolved in 8 parts by mass of methanol, the obtained mixture was added to 0.0209 parts by mass of hexamethyl tris(2-aminoethyl)amine (Me₆TREN), the obtained mixture was then added to a reaction system, and the raw materials in the reaction system were mixed. Further, 0.799 parts by mass of ascorbic acid and 0.918 parts by mass of triethylamine were adjusted by 14.3 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 89% (total monomer consumption of 18%) after 240 minutes from the start of dropping of the ascorbic acid solution, 80 parts by mass of 2-methoxyethyl acrylate was added dropwise to the reaction system over 75 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 96% after 410 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 12.

The obtained one-terminal-Br group-containing polymer 12 was converted to a one-terminal acryloyl group in the same manner as Production Example 1, and a one-terminal-acryloyl group-containing macromonomer 12 containing a large number of constituent units derived from the acrylonitrile on a side opposite to the terminal of the acryloyl group was obtained. A number average molecular weight of the obtained one-terminal-acryloyl group-containing macromonomer 12 was 6000, and a molecular weight distribution (a weight average molecular weight/the number average molecular weight) thereof was 1.2. The one-terminal-acryloyl group-containing macromonomer 12 contained 90 mol % of all the constituent units derived from the acrylonitrile in a terminal region including a terminal on the side opposite to the terminal of the acryloyl group and including half of the number of all constituent units in the one-terminal-acryloyl group-containing macromonomer 12.

### Production Example 13

80 parts by mass of 2-methoxyethyl acrylate, 12 parts by mass of methanol (MeOH), 3.54 parts by mass of ethyl 2-bromobutyrate, and 0.18 parts by mass of triethylamine were added to a reaction vessel, and the added raw materials were stirred at 40° C. in a nitrogen atmosphere. Next, 0.0203 parts by mass of copper (II) bromide (CuBr₂) was dissolved in 8 parts by mass of methanol, the obtained mixture was added to 0.0209 parts by mass of hexamethyl tris(2-aminoethyl)amine (Me₆TREN), the obtained mixture was then added to a reaction system, and the raw materials in the reaction system were mixed. Further, 0.799 parts by mass of ascorbic acid and 0.918 parts by mass of triethylamine were adjusted by 14.3 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 87% (total monomer consumption of 70%) after 120 minutes from the start of dropping of the ascorbic acid solution, 4.3 parts by mass of acrylonitrile and 15.7 parts by mass of 2-methoxyethyl acrylate were added dropwise to the reaction system over 60 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 95% after 390 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 13.

The obtained one-terminal-Br group-containing polymer 13 was converted to a one-terminal acryloyl group in the same manner as Production Example 1, and a one-terminal-acryloyl group-containing macromonomer 13 containing a large number of constituent units derived from the acrylonitrile on a side of the terminal of the acryloyl group was obtained. A number average molecular weight of the obtained one-terminal-acryloyl group-containing macromonomer 13 was 6000, and a molecular weight distribution (a weight average molecular weight/the number average molecular weight) thereof was 1.2. The one-terminal-acryloyl group-containing macromonomer 13 contained 100 mol % of all the constituent units derived from the acrylonitrile in a non-terminal region including the terminal of the acryloyl group and including half of the number of all constituent units in the one-terminal-acryloyl group-containing macromonomer 13.

### Production Example 14

9.3 parts by mass of acrylonitrile, 10.7 parts by mass of 2-methoxyethyl acrylate, 12 parts by mass of methanol (MeOH), 3.78 parts by mass of ethyl 2-bromobutyrate, and 0.18 parts by mass of triethylamine were added to a reaction vessel, and the added raw materials were stirred at 40° C. in a nitrogen atmosphere. Next, 0.0216 parts by mass of copper (II) bromide (CuBr₂) was dissolved in 8 parts by mass of methanol, the obtained mixture was added to 0.0223 parts by mass of hexamethyl tris(2-aminoethyl)amine (Me₆TREN), the obtained mixture was then added to a reaction system, and the raw materials in the reaction system were mixed. Further, 0.799 parts by mass of ascorbic acid and 0.918 parts by mass of triethylamine were adjusted by 14.3 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 84% (total monomer consumption of 17%) after 200 minutes from the start of dropping of the ascorbic acid solution, 80.0 parts by mass of 2-methoxyethyl acrylate was added dropwise to the reaction system over 75 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 94% after 410 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 14.

The obtained one-terminal-Br group-containing polymer 14 was converted to a one-terminal acryloyl group in the same manner as Production Example 1, and a one-terminal-acryloyl group-containing macromonomer 14 containing a large number of constituent units derived from the acrylonitrile on a side opposite to the terminal of the acryloyl group was obtained. A number average molecular weight of the obtained one-terminal-acryloyl group-containing macromonomer 14 was 6000, and a molecular weight distribution (a weight average molecular weight/the number average molecular weight) thereof was 1.2. The one-terminal-acryloyl group-containing macromonomer 14 contained 90 mol % of all the constituent units derived from the acrylonitrile in a terminal region including a terminal on the side opposite to the terminal of the acryloyl group and including half of the number of all constituent units in the one-terminal-acryloyl group-containing macromonomer 14.

### Production Example 15

80 parts by mass of 2-methoxyethyl acrylate, 12 parts by mass of methanol (MeOH), 3.78 parts by mass of ethyl 2-bromobutyrate, and 0.18 parts by mass of triethylamine were added to a reaction vessel, and the added raw materials were stirred at 40° C. in a nitrogen atmosphere. Next, 0.0216 parts by mass of copper (II) bromide (CuBr₂) was dissolved in 8 parts by mass of methanol, the obtained mixture was added to 0.0223 parts by mass of hexamethyl tris(2-aminoethyl)amine (Me₆TREN), the obtained mixture was then added to a reaction system, and the raw materials in the reaction system were mixed. Further, 0.799 parts by mass of ascorbic acid and 0.918 parts by mass of triethylamine were adjusted by 14.3 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 76% (total monomer consumption of 61%) after 120 minutes from the start of dropping of the ascorbic acid solution, 9.3 parts by mass of acrylonitrile and 10.7 parts by mass of 2-methoxyethyl acrylate were added dropwise to the reaction system over 60 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 95% after 390 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 15.

The obtained one-terminal-Br group-containing polymer 15 was converted to a one-terminal acryloyl group in the same manner as Production Example 1, and a one-terminal-acryloyl group-containing macromonomer 15 containing a large number of constituent units derived from the acrylonitrile on a side of the terminal of the acryloyl group was obtained. A number average molecular weight of the obtained one-terminal-acryloyl group-containing macromonomer 15 was 6000, and a molecular weight distribution (a weight average molecular weight/the number average molecular weight) thereof was 1.2. The one-terminal-acryloyl group-containing macromonomer 15 contained 100 mol % of all the constituent units derived from the acrylonitrile in a non-terminal region including the terminal of the acryloyl group and including half of the number of all constituent units in the one-terminal-acryloyl group-containing macromonomer 15.

### Production Example 16

40 parts by mass of 2-methoxyethyl acrylate, 12 parts by mass of methanol (MeOH), 3.33 parts by mass of ethyl 2-bromobutyrate, and 0.18 parts by mass of triethylamine were added to a reaction vessel, and the added raw materials were stirred at 40° C. in a nitrogen atmosphere. Next, 0.0191 parts by mass of copper (II) bromide (CuBr₂) was dissolved in 8 parts by mass of methanol, the obtained mixture was added to 0.0197 parts by mass of hexamethyl tris(2-aminoethyl)amine (Me₆TREN), the obtained mixture was then added to a reaction system, and the raw materials in the reaction system were mixed. Further, 0.015 parts by mass of ascorbic acid and 0.017 parts by mass of triethylamine were adjusted by 3.0 parts by mass of methanol, and the obtained ascorbic acid solution was dripped into the reaction system to initiate polymerization. During the polymerization, heating and stirring of a reaction solution were continued while a dropping rate of the ascorbic acid solution was adjusted so that a temperature of the reaction solution was 40° C. or higher and 60° C. or lower. When monomer consumption in the reaction vessel reached 37% (total monomer consumption of 15%) after 60 minutes from the start of dropping of the ascorbic acid solution, 60 parts by mass of 2-methoxyethyl acrylate was added dropwise to the reaction system over 60 minutes. Thereafter, the heating and the stirring of the reaction solution were continued while the dropping rate of the ascorbic acid solution into the reaction system was adjusted so that the temperature of the reaction vessel was 40° C. or higher and 60° C. or lower. When the monomer consumption in the reaction vessel reached 95% after 310 minutes from the start of dropping of the ascorbic acid solution, the dropping of the ascorbic acid was stopped and the reaction ended. An obtained reaction product was diluted with toluene and was passed through an activated alumina column, and then a volatile component was distilled off under reduced pressure to obtain a one-terminal-Br group-containing polymer 16.

The obtained one-terminal-Br group-containing polymer 16 was converted to a one-terminal acryloyl group in the same manner as Production Example 1, and a one-terminal-acryloyl group-containing macromonomer 16 not containing a constituent unit derived from the acrylonitrile was obtained. A number average molecular weight of the obtained one-terminal-acryloyl group-containing macromonomer 16 was 6000, and a molecular weight distribution (a weight average molecular weight/the number average molecular weight) thereof was 1.2.

### Production of Thermoplastic Modacrylic Resin

### Example 1

54 parts by mass of vinyl chloride, 7 parts by mass of acrylonitrile, 3 parts by mass of the one-terminal-acryloyl group-containing macromonomer 1 obtained in Production Example 1, 210 parts by mass of ion exchange water, 0.25 parts by mass of partially saponified polyvinyl acetate (a degree of saponification is about 70 mol %, and an average polymerization degree is 1700), and 0.75 parts by mass of 1,1,3,3-tetramethylbutyl peroxyneodecanoate were added to a polymerization reactor, and then the mixture was stirred and dispersed for 15 minutes in a state in which an internal temperature of the polymerization reactor was cooled to 15° C. or lower. Thereafter, the internal temperature of the polymerization reactor was raised to 45° C. to initiate polymerization, and a polymerization temperature was raised to 52.5° C. for 3 hours, and then the polymerization temperature was raised to 55° C. to perform suspension polymerization for 3 hours. In the polymerization, 36 parts by mass of acrylonitrile and 0.5 parts by mass of 2-mercaptoethanol were continuously added at a constant speed for a period from immediately after the start of the polymerization to 5 hours. An unreacted monomer in the polymerization reactor was recovered, and then a slurry was discharged. The obtained slurry was dehydrated and dried at 60° C. for 24 hours by using a hot-air dryer to obtain a thermoplastic modacrylic resin 1 containing a copolymer 1. Regarding the obtained thermoplastic modacrylic resin 1, a constituent unit derived from the vinyl chloride was 52.9 mass %, a constituent unit derived from the acrylonitrile was 44.1 mass %, a constituent unit derived from the one-terminal-acryloyl group-containing macromonomer 1 was 3.0 mass %, a weight average molecular weight was about 47000, a molecular weight distribution (the weight average molecular weight/a number average molecular weight) was 2.22, and a specific viscosity was 0.100.

### Example 2

A thermoplastic modacrylic resin 2 containing a copolymer 2 was obtained in the same manner as Example 1 except that the one-terminal-acryloyl group-containing macromonomer 2 obtained in Production Example 2 was used instead of the one-terminal-acryloyl group-containing macromonomer 1 obtained in Production Example 1. Regarding the obtained thermoplastic modacrylic resin 2, a constituent unit derived from the vinyl chloride was 52.0 mass %, a constituent unit derived from the acrylonitrile was 45.0 mass %, a constituent unit derived from the one-terminal-acryloyl group-containing macromonomer 2 was 3.0 mass %, a weight average molecular weight was about 56600, a molecular weight distribution (the weight average molecular weight/a number average molecular weight) was 2.45, and a specific viscosity was 0.109.

### Example 3

A thermoplastic modacrylic resin 3 containing a copolymer 3 was obtained in the same manner as Example 1 except that the one-terminal-acryloyl group-containing macromonomer 3 obtained in Production Example 3 was used instead of the one-terminal-acryloyl group-containing macromonomer 1 obtained in Production Example 1. Regarding the obtained thermoplastic modacrylic resin 3, a constituent unit derived from the vinyl chloride was 53.4 mass %, a constituent unit derived from the acrylonitrile was 43.6 mass %, a constituent unit derived from the one-terminal-acryloyl group-containing macromonomer 3 was 3.0 mass %, a weight average molecular weight was about 45900, a molecular weight distribution (the weight average molecular weight/a number average molecular weight) was 2.45, and a specific viscosity was 0.113.

### Example 4

A thermoplastic modacrylic resin 4 containing a copolymer 4 was obtained in the same manner as Example 1 except that the one-terminal-acryloyl group-containing macromonomer 4 obtained in Production Example 4 was used instead of the one-terminal-acryloyl group-containing macromonomer 1 obtained in Production Example 1. Regarding the obtained thermoplastic modacrylic resin 4, a constituent unit derived from the vinyl chloride was 51.8 mass %, a constituent unit derived from the acrylonitrile was 45.2 mass %, a constituent unit derived from the one-terminal-acryloyl group-containing macromonomer 4 was 3.0 mass %, a weight average molecular weight was about 54900, a molecular weight distribution (the weight average molecular weight/a number average molecular weight) was 2.51, and a specific viscosity was 0.115.

### Example 5

A thermoplastic modacrylic resin 5 containing a copolymer 5 was obtained in the same manner as Example 1 except that the one-terminal-acryloyl group-containing macromonomer 5 obtained in Production Example 5 was used instead of the one-terminal-acryloyl group-containing macromonomer 1 obtained in Production Example 1. Regarding the obtained thermoplastic modacrylic resin 5, a constituent unit derived from the vinyl chloride was 51.0 mass %, a constituent unit derived from the acrylonitrile was 46.0 mass %, a constituent unit derived from the one-terminal-acryloyl group-containing macromonomer 5 was 3.0 mass %, a weight average molecular weight was about 47500, a molecular weight distribution (the weight average molecular weight/a number average molecular weight) was 2.33, and a specific viscosity was 0.091.

### Example 6

A thermoplastic modacrylic resin 6 containing a copolymer 6 was obtained in the same manner as Example 1 except that the one-terminal-acryloyl group-containing macromonomer 6 obtained in Production Example 6 was used instead of the one-terminal-acryloyl group-containing macromonomer 1 obtained in Production Example 1. Regarding the obtained thermoplastic modacrylic resin 6, a constituent unit derived from the vinyl chloride was 55.8 mass %, a constituent unit derived from the acrylonitrile was 41.2 mass %, a constituent unit derived from the one-terminal-acryloyl group-containing macromonomer 6 was 3.0 mass %, a weight average molecular weight was about 48100, a molecular weight distribution (the weight average molecular weight/a number average molecular weight) was 2.22, and a specific viscosity was 0.105.

### Example 7

A thermoplastic modacrylic resin 7 containing a copolymer 7 was obtained in the same manner as Example 1 except that the one-terminal-acryloyl group-containing macromonomer 7 obtained in Production Example 7 was used instead of the one-terminal-acryloyl group-containing macromonomer 1 obtained in Production Example 1. Regarding the obtained thermoplastic modacrylic resin 7, a constituent unit derived from the vinyl chloride was 57.2 mass %, a constituent unit derived from the acrylonitrile was 39.8 mass %, a constituent unit derived from the one-terminal-acryloyl group-containing macromonomer 7 was 3.0 mass %, a weight average molecular weight was about 43600, a molecular weight distribution (the weight average molecular weight/a number average molecular weight) was 2.42, and a specific viscosity was 0.101.

### Example 8

A thermoplastic modacrylic resin 8 containing a copolymer 8 was obtained in the same manner as Example 1 except that the one-terminal-acryloyl group-containing macromonomer 8 obtained in Production Example 8 was used instead of the one-terminal-acryloyl group-containing macromonomer 1 obtained in Production Example 1. Regarding the obtained thermoplastic modacrylic resin 8, a constituent unit derived from the vinyl chloride was 55.7 mass %, a constituent unit derived from the acrylonitrile was 41.3 mass %, a constituent unit derived from the one-terminal-acryloyl group-containing macromonomer 8 was 3.0 mass %, a weight average molecular weight was about 46500, a molecular weight distribution (the weight average molecular weight/a number average molecular weight) was 2.55, and a specific viscosity was 0.102.

### Example 9

A thermoplastic modacrylic resin 9 containing a copolymer 9 was obtained in the same manner as Example 1 except that the one-terminal-acryloyl group-containing macromonomer 9 obtained in Production Example 9 was used instead of the one-terminal-acryloyl group-containing macromonomer 1 obtained in Production Example 1. Regarding the obtained thermoplastic modacrylic resin 9, a constituent unit derived from the vinyl chloride was 54.4 mass %, a constituent unit derived from the acrylonitrile was 42.6 mass %, a constituent unit derived from the one-terminal-acryloyl group-containing macromonomer 9 was 3.0 mass %, a weight average molecular weight was about 50200, a molecular weight distribution (the weight average molecular weight/a number average molecular weight) was 2.57, and a specific viscosity was 0.098.

### Example 10

A thermoplastic modacrylic resin 10 containing a copolymer 10 was obtained in the same manner as Example 1 except that the one-terminal-acryloyl group-containing macromonomer 10 obtained in Production Example 10 was used instead of the one-terminal-acryloyl group-containing macromonomer 1 obtained in Production Example 1. Regarding the obtained thermoplastic modacrylic resin 10, a constituent unit derived from the vinyl chloride was 54.6 mass %, a constituent unit derived from the acrylonitrile was 42.4 mass %, a constituent unit derived from the one-terminal-acryloyl group-containing macromonomer 10 was 3.0 mass %, a weight average molecular weight was about 53500, a molecular weight distribution (the weight average molecular weight/a number average molecular weight) was 2.59, and a specific viscosity was 0.102.

### Comparative Example 1

A thermoplastic modacrylic resin 11 containing a copolymer 11 was obtained in the same manner as Example 1 except that the one-terminal-acryloyl group-containing macromonomer 11 obtained in Production Example 11 was used instead of the one-terminal-acryloyl group-containing macromonomer 1 obtained in Production Example 1. Regarding the obtained thermoplastic modacrylic resin 11, a constituent unit derived from the vinyl chloride was 53.5 mass %, a constituent unit derived from the acrylonitrile was 43.5 mass %, a constituent unit derived from the one-terminal-acryloyl group-containing macromonomer 11 was 3.0 mass %, a weight average molecular weight was about 44200, a molecular weight distribution (the weight average molecular weight/a number average molecular weight) was 2.40, and a specific viscosity was 0.104.

### Comparative Example 2

A thermoplastic modacrylic resin 12 containing a copolymer 12 was obtained in the same manner as Example 1 except that the one-terminal-acryloyl group-containing macromonomer 12 obtained in Production Example 12 was used instead of the one-terminal-acryloyl group-containing macromonomer 1 obtained in Production Example 1. Regarding the obtained thermoplastic modacrylic resin 12, a constituent unit derived from the vinyl chloride was 53.3 mass %, a constituent unit derived from the acrylonitrile was 43.7 mass %, a constituent unit derived from the one-terminal-acryloyl group-containing macromonomer 12 was 3.0 mass %, a weight average molecular weight was about 46700, a molecular weight distribution (the weight average molecular weight/a number average molecular weight) was 2.35, and a specific viscosity was 0.108.

### Comparative Example 3

A thermoplastic modacrylic resin 13 containing a copolymer 13 was obtained in the same manner as Example 1 except that the one-terminal-acryloyl group-containing macromonomer 13 obtained in Production Example 13 was used instead of the one-terminal-acryloyl group-containing macromonomer 1 obtained in Production Example 1. Regarding the obtained thermoplastic modacrylic resin 13, a constituent unit derived from the vinyl chloride was 53.6 mass %, a constituent unit derived from the acrylonitrile was 43.4 mass %, a constituent unit derived from the one-terminal-acryloyl group-containing macromonomer 13 was 3.0 mass %, a weight average molecular weight was about 49800, a molecular weight distribution (the weight average molecular weight/a number average molecular weight) was 2.45, and a specific viscosity was 0.123.

### Comparative Example 4

A thermoplastic modacrylic resin 14 containing a copolymer 14 was obtained in the same manner as Example 1 except that the one-terminal-acryloyl group-containing macromonomer 14 obtained in Production Example 14 was used instead of the one-terminal-acryloyl group-containing macromonomer 1 obtained in Production Example 1. Regarding the obtained thermoplastic modacrylic resin 14, a constituent unit derived from the vinyl chloride was 52.4 mass %, a constituent unit derived from the acrylonitrile was 44.6 mass %, a constituent unit derived from the one-terminal-acryloyl group-containing macromonomer 14 was 3.0 mass %, a weight average molecular weight was about 50900, a molecular weight distribution (the weight average molecular weight/a number average molecular weight) was 2.43, and a specific viscosity was 0.104.

### Comparative Example 5

A thermoplastic modacrylic resin 15 containing a copolymer 15 was obtained in the same manner as Example 1 except that the one-terminal-acryloyl group-containing macromonomer 15 obtained in Production Example 15 was used instead of the one-terminal-acryloyl group-containing macromonomer 1 obtained in Production Example 1. Regarding the obtained thermoplastic modacrylic resin 15, a constituent unit derived from the vinyl chloride was 53.8 mass %, a constituent unit derived from the acrylonitrile was 43.2 mass %, a constituent unit derived from the one-terminal-acryloyl group-containing macromonomer 15 was 3.0 mass %, a weight average molecular weight was about 43700, a molecular weight distribution (the weight average molecular weight/a number average molecular weight) was 2.37, and a specific viscosity was 0.085.

### Comparative Example 6

A thermoplastic modacrylic resin 16 containing a copolymer 16 was obtained in the same manner as Example 1 except that the one-terminal-acryloyl group-containing macromonomer 16 obtained in Production Example 16 was used instead of the one-terminal-acryloyl group-containing macromonomer 1 obtained in Production Example 1. Regarding the obtained thermoplastic modacrylic resin 16, a constituent unit derived from the vinyl chloride was 56.0 mass %, a constituent unit derived from the acrylonitrile was 41.0 mass %, a constituent unit derived from the one-terminal-acryloyl group-containing macromonomer 16 was 3.0 mass %, a weight average molecular weight was about 47600, a molecular weight distribution (the weight average molecular weight/a number average molecular weight) was 2.49, and a specific viscosity was 0.111.

### Production of Fibers

### Example A1

### Production of Pellets of Thermoplastic Modacrylic Resin Composition

2.5 parts by mass of dimethyl sulfone as the plasticizer, 1.5 parts by mass of hydrotalcite (manufactured by Kyowa Chemical Industry Co., Ltd., product name “ALCAMIZER (registered trademark) 1”) as the stabilizer, 0.15 parts by mass of a fatty acid ester-based lubricant (manufactured by RIKEN VITAMIN CO., LTD., product name “EW-100”) as the lubricant, 0.2 parts by mass of a (meth)acrylate-based polymer (manufactured by Kaneka Corporation, product name “Kane Ace PA20”), 0.3 parts by mass of calcium soap ▪ zinc soap, 0.4 parts by mass of β-diketone, and 0.2 parts by mass of stearic acid (manufactured by NOF Corporation, product name “Stearic Acid Sakura”) were added as additives with respect to 100 parts by mass of the thermoplastic modacrylic resin 1 obtained in Example 1, the mixture was heated to 110° C. while being mixed by using a Henschel mixer, and then the mixture was cooled to 50° C. to obtain a powder mixture. Next, the powder mixture was extruded by a laboratory extruder (manufactured by Toyo Seiki Co., Ltd., model number “4C150”, a combination of a 20 mm extrusion unit and a 2 mm strand nozzle) to obtain a strand. The extruder operated in a temperature range of 110° C. or higher and 150° C. or lower. The obtained strand was air-cooled and then pelletized.

### Melt Spinning of Modacrylic Fibers

The obtained pellets of the thermoplastic modacrylic resin composition were extruded at a cylinder temperature of 120° C. to 170° C. and a nozzle temperature of 210° C.±20° C. by using a laboratory extruder (manufactured by Toyo Seiki Co., Ltd., model number “4C150”, a combination of a 20 mm extrusion unit and a circular spinning nozzle having a hole cross-sectional area of 0.12 mm² in a downward die for melt viscosity measurement and 12 holes) and were melt-spun. Undrawn yarn fibers having a fineness of 150 dtex were obtained by being taken along at about 10 times nozzle draft. The obtained undrawn yarn fibers were subjected to dry heat drawing at a draw ratio of 270% in a dry heat atmosphere at 100° C., and then were relaxed by 5% to obtain modacrylic fibers having a single fiber fineness of about 58.5 dtex and a strength of 1.70 cN/dtex. Regarding the obtained modacrylic fibers, both the spinning time at 150 dtex and the spinning time at 100 dtex were slightly more than 180 seconds, and the minimum fineness was 30 dtex.

### Example A2

### Production of Pellets of Thermoplastic Modacrylic Resin Composition

Pellets of the thermoplastic modacrylic resin composition were obtained in the same manner as Example A1 except that the thermoplastic modacrylic resin 2 obtained in Example 2 was used.

### Melt Spinning of Modacrylic Fibers

The melt spinning was performed in the same manner as Example A1 except that the obtained pellets of the thermoplastic modacrylic resin composition were used. Undrawn yarn fibers having a fineness of 150 dtex were obtained by being taken along at about 10 times nozzle draft. The obtained undrawn yarn fibers were subjected to dry heat drawing at a draw ratio of 270% in a dry heat atmosphere at 100° C., and then were relaxed by 5% to obtain modacrylic fibers having a single fiber fineness of about 58.5 dtex and a strength of 2.00 cN/dtex. Regarding the obtained modacrylic fibers, the spinning time at 150 dtex was slightly more than 180 seconds, the spinning time at 100 dtex was 60 seconds, and the minimum fineness was 100 dtex.

### Example A3

### Production of Pellets of Thermoplastic Modacrylic Resin Composition

Pellets of the thermoplastic modacrylic resin composition were obtained in the same manner as Example A1 except that the thermoplastic modacrylic resin 3 obtained in Example 3 was used.

### Melt Spinning of Modacrylic Fibers

The melt spinning was performed in the same manner as Example A1 except that the obtained pellets of the thermoplastic modacrylic resin composition were used. Undrawn yarn fibers having a fineness of 150 dtex were obtained by being taken along at about 10 times nozzle draft. The obtained undrawn yarn fibers were subjected to dry heat drawing at a draw ratio of 270% in a dry heat atmosphere at 100° C., and then were relaxed by 5% to obtain modacrylic fibers having a single fiber fineness of about 58.5 dtex and a strength of 1.78 cN/dtex. Regarding the obtained modacrylic fibers, both the spinning time at 150 dtex and the spinning time at 100 dtex were slightly more than 120 seconds, and the minimum fineness was 60 dtex.

### Example A4

### Production of Pellets of Thermoplastic Modacrylic Resin Composition

Pellets of the thermoplastic modacrylic resin composition were obtained in the same manner as Example A1 except that the thermoplastic modacrylic resin 4 obtained in Example 4 was used.

### Melt Spinning of Modacrylic Fibers

The melt spinning was performed in the same manner as Example A1 except that the obtained pellets of the thermoplastic modacrylic resin composition were used. Undrawn yarn fibers having a fineness of 125 dtex were obtained by being taken along at about 13 times nozzle draft. The obtained undrawn yarn fibers were subjected to dry heat drawing at a draw ratio of 200% in a dry heat atmosphere at 100° C., and then were relaxed by 5% to obtain modacrylic fibers having a single fiber fineness of about 65.8 dtex and a strength of 1.50 cN/dtex. Regarding the obtained modacrylic fibers, the spinning time at 150 dtex was 90 seconds, the spinning time at 100 dtex was slightly less than 5 seconds, and the minimum fineness was 125 dtex.

### Example A5

### Production of Pellets of Thermoplastic Modacrylic Resin Composition

Pellets of the thermoplastic modacrylic resin composition were obtained in the same manner as Example A1 except that the thermoplastic modacrylic resin 5 obtained in Example 5 was used.

### Melt Spinning of Modacrylic Fibers

The melt spinning was performed in the same manner as Example A1 except that the obtained pellets of the thermoplastic modacrylic resin composition were used. Undrawn yarn fibers having a fineness of 150 dtex were obtained by being taken along at about 10 times nozzle draft. The obtained undrawn yarn fibers were subjected to dry heat drawing at a draw ratio of 270% in a dry heat atmosphere at 100° C., and then were relaxed by 5% to obtain modacrylic fibers having a single fiber fineness of about 58.5 dtex and a strength of 1.51 cN/dtex. Regarding the obtained modacrylic fibers, the spinning time at 150 dtex was 30 seconds, the spinning time at 100 dtex was 0 seconds, and the minimum fineness was 150 dtex.

### Example A6

### Production of Pellets of Thermoplastic Modacrylic Resin Composition

Pellets of the thermoplastic modacrylic resin composition were obtained in the same manner as Example A1 except that the thermoplastic modacrylic resin 6 obtained in Example 6 was used and the addition amount of the dimethyl sulfone was changed to 0.5 parts by mass.

### Melt Spinning of Modacrylic Fibers

The melt spinning was performed in the same manner as Example A1 except that the obtained pellets of the thermoplastic modacrylic resin composition were used. Undrawn yarn fibers having a fineness of 150 dtex were obtained by being taken along at about 10 times nozzle draft. The obtained undrawn yarn fibers were subjected to dry heat drawing at a draw ratio of 295% in a dry heat atmosphere at 105° C., and then were relaxed by 5% to obtain modacrylic fibers having a single fiber fineness of about 53.5 dtex and a strength of 1.58 cN/dtex. Regarding the obtained modacrylic fibers, the spinning time at 150 dtex was 60 seconds, the spinning time at 100 dtex was 0 seconds, and the minimum fineness was 150 dtex.

### Example A7

### Production of Pellets of Thermoplastic Modacrylic Resin Composition

Pellets of the thermoplastic modacrylic resin composition were obtained in the same manner as Example A1 except that the thermoplastic modacrylic resin 7 obtained in Example 7 was used and the addition amount of the dimethyl sulfone was changed to 0.5 parts by mass.

### Melt Spinning of Modacrylic Fibers

The melt spinning was performed in the same manner as Example A1 except that the obtained pellets of the thermoplastic modacrylic resin composition were used. Undrawn yarn fibers having a fineness of 150 dtex were obtained by being taken along at about 10 times nozzle draft. The obtained undrawn yarn fibers were subjected to dry heat drawing at a draw ratio of 295% in a dry heat atmosphere at 105° C., and then were relaxed by 5% to obtain modacrylic fibers having a single fiber fineness of about 53.5 dtex and a strength of 1.52 cN/dtex. Regarding the obtained modacrylic fibers, the spinning time at 150 dtex was slightly more than 300 seconds, the spinning time at 100 dtex was slightly more than 300 seconds, and the minimum fineness was 50 dtex.

### Example A8

### Production of Pellets of Thermoplastic Modacrylic Resin Composition

Pellets of the thermoplastic modacrylic resin composition were obtained in the same manner as Example A1 except that the thermoplastic modacrylic resin 8 obtained in Example 8 was used and the addition amount of the dimethyl sulfone was changed to 0.5 parts by mass.

### Melt Spinning of Modacrylic Fibers

The melt spinning was performed in the same manner as Example A1 except that the obtained pellets of the thermoplastic modacrylic resin composition were used. Undrawn yarn fibers having a fineness of 150 dtex were obtained by being taken along at about 10 times nozzle draft. The obtained undrawn yarn fibers were subjected to dry heat drawing at a draw ratio of 295% in a dry heat atmosphere at 105° C., and then were relaxed by 5% to obtain modacrylic fibers having a single fiber fineness of about 53.5 dtex and a strength of 1.58 cN/dtex. Regarding the obtained modacrylic fibers, the spinning time at 150 dtex was slightly more than 300 seconds, the spinning time at 100 dtex was slightly more than 300 seconds, and the minimum fineness was 35 dtex.

### Example A9

### Production of Pellets of Thermoplastic Modacrylic Resin Composition

Pellets of the thermoplastic modacrylic resin composition were obtained in the same manner as Example A1 except that the thermoplastic modacrylic resin 9 obtained in Example 9 was used and the addition amount of the dimethyl sulfone was changed to 0.5 parts by mass.

### Melt Spinning of Modacrylic Fibers

The melt spinning was performed in the same manner as Example A1 except that the obtained pellets of the thermoplastic modacrylic resin composition were used. Undrawn yarn fibers having a fineness of 150 dtex were obtained by being taken along at about 10 times nozzle draft. The obtained undrawn yarn fibers were subjected to dry heat drawing at a draw ratio of 295% in a dry heat atmosphere at 105° C., and then were relaxed by 5% to obtain modacrylic fibers having a single fiber fineness of about 53.5 dtex and a strength of 1.68 cN/dtex. Regarding the obtained modacrylic fibers, the spinning time at 150 dtex was 150 seconds, the spinning time at 100 dtex was 0 seconds, and the minimum fineness was 125 dtex.

### Example A10

### Production of Pellets of Thermoplastic Modacrylic Resin Composition

Pellets of the thermoplastic modacrylic resin composition were obtained in the same manner as Example A1 except that the thermoplastic modacrylic resin 10 obtained in Example 10 was used and the addition amount of the dimethyl sulfone was changed to 0.5 parts by mass.

### Melt Spinning of Modacrylic Fibers

The melt spinning was performed in the same manner as Example A1 except that the obtained pellets of the thermoplastic modacrylic resin composition were used. Undrawn yarn fibers having a fineness of 150 dtex were obtained by being taken along at about 10 times nozzle draft. The obtained undrawn yarn fibers were subjected to dry heat drawing at a draw ratio of 295% in a dry heat atmosphere at 105° C., and then were relaxed by 5% to obtain modacrylic fibers having a single fiber fineness of about 53.5 dtex and a strength of 2.03 cN/dtex. Regarding the obtained modacrylic fibers, the spinning time at 150 dtex was slightly more than 180 seconds, the spinning time at 100 dtex was 90 seconds, and the minimum fineness was 80 dtex.

### Comparative Example A1

### Production of Pellets of Thermoplastic Modacrylic Resin Composition

Pellets of the thermoplastic modacrylic resin composition were obtained in the same manner as Example A1 except that the thermoplastic modacrylic resin 11 obtained in Comparative Example 1 was used.

### Melt Spinning of Modacrylic Fibers

The melt spinning was performed in the same manner as Example A1 except that the obtained pellets of the thermoplastic modacrylic resin composition were used. Undrawn yarn fibers having a fineness of 150 dtex were obtained by being taken along at about 10 times nozzle draft. The obtained undrawn yarn fibers were subjected to dry heat drawing at a draw ratio of 270% in a dry heat atmosphere at 100° C., and then were relaxed by 5% to obtain modacrylic fibers having a single fiber fineness of about 58.5 dtex and a strength of 1.23 cN/dtex. Regarding the obtained modacrylic fibers, the spinning time at 150 dtex was 120 seconds, the spinning time at 100 dtex was 0 seconds, and the minimum fineness was 125 dtex.

### Comparative Example A2

### Production of Pellets of Thermoplastic Modacrylic Resin Composition

Pellets of the thermoplastic modacrylic resin composition were obtained in the same manner as Example A1 except that the thermoplastic modacrylic resin 12 obtained in Comparative Example 2 was used.

### Melt Spinning of Modacrylic Fibers

The melt spinning was performed in the same manner as Example A1 except that the obtained pellets of the thermoplastic modacrylic resin composition were used. Undrawn yarn fibers having a fineness of 150 dtex were obtained by being taken along at about 10 times nozzle draft. The obtained undrawn yarn fibers were subjected to dry heat drawing at a draw ratio of 270% in a dry heat atmosphere at 100° C., and then were relaxed by 5% to obtain modacrylic fibers having a single fiber fineness of about 58.5 dtex and a strength of 1.78 cN/dtex. Regarding the obtained modacrylic fibers, the spinning time at 150 dtex was 120 seconds, the spinning time at 100 dtex was 30 seconds, and the minimum fineness was 100 dtex.

### Comparative Example A3

### Production of Pellets of Thermoplastic Modacrylic Resin Composition

Pellets of the thermoplastic modacrylic resin composition were obtained in the same manner as Example A1 except that the thermoplastic modacrylic resin 13 obtained in Comparative Example 3 was used.

### Melt Spinning of Modacrylic Fibers

The melt spinning was performed in the same manner as Example A1 except that the obtained pellets of the thermoplastic modacrylic resin composition were used. Undrawn yarn fibers having a fineness of 125 dtex were obtained by being taken along at about 13 times nozzle draft. The obtained undrawn yarn fibers were subjected to dry heat drawing at a draw ratio of 200% in a dry heat atmosphere at 100° C., and then were relaxed by 5% to obtain modacrylic fibers having a single fiber fineness of about 65.8 dtex and a strength of 1.29 cN/dtex. Regarding the obtained modacrylic fibers, the spinning time at 150 dtex was 120 seconds, the spinning time at 100 dtex was 15 seconds, and the minimum fineness was 100 dtex.

### Comparative Example A4

### Production of Pellets of Thermoplastic Modacrylic Resin Composition

Pellets of the thermoplastic modacrylic resin composition were obtained in the same manner as Example A1 except that the thermoplastic modacrylic resin 14 obtained in Comparative Example 4 was used.

### Melt Spinning of Modacrylic Fibers

The melt spinning was performed in the same manner as Example A1 except that the obtained pellets of the thermoplastic modacrylic resin composition were used. Undrawn yarn fibers having a fineness of 150 dtex were obtained by being taken along at about 10 times nozzle draft. The obtained undrawn yarn fibers were subjected to dry heat drawing at a draw ratio of 270% in a dry heat atmosphere at 100° C., and then were relaxed by 5% to obtain modacrylic fibers having a single fiber fineness of about 58.5 dtex and a strength of 1.76 cN/dtex. Regarding the obtained modacrylic fibers, the spinning time at 150 dtex was 10 seconds, the spinning time at 100 dtex was 0 seconds, and the minimum fineness was 150 dtex.

### Comparative Example A5

### Production of Pellets of Thermoplastic Modacrylic Resin Composition

Pellets of the thermoplastic modacrylic resin composition were obtained in the same manner as Example A1 except that the thermoplastic modacrylic resin 15 obtained in Comparative Example 5 was used.

### Melt Spinning of Modacrylic Fibers

The melt spinning was performed in the same manner as Example A1 except that the obtained pellets of the thermoplastic modacrylic resin composition were used. Undrawn yarn fibers having a fineness of 150 dtex were obtained by being taken along at about 10 times nozzle draft. The obtained undrawn yarn fibers were subjected to dry heat drawing at a draw ratio of 270% in a dry heat atmosphere at 100° C., and then were relaxed by 5% to obtain modacrylic fibers having a single fiber fineness of about 58.5 dtex and a strength of 1.39 cN/dtex. Regarding the obtained modacrylic fibers, the spinning time at 150 dtex was slightly more than 180 seconds, the spinning time at 100 dtex was 60 seconds, and the minimum fineness was 75 dtex.

### Comparative Example A6

### Production of Pellets of Thermoplastic Modacrylic Resin Composition

Pellets of the thermoplastic modacrylic resin composition were obtained in the same manner as Example A1 except that the thermoplastic modacrylic resin 16 obtained in Comparative Example 6 was used and the addition amount of the dimethyl sulfone was changed to 0.5 parts by mass.

### Melt Spinning of Modacrylic Fibers

The melt spinning was performed in the same manner as Example A1 except that the obtained pellets of the thermoplastic modacrylic resin composition were used. Undrawn yarn fibers having a fineness of 150 dtex were obtained by being taken along at about 10 times nozzle draft. The obtained undrawn yarn fibers were subjected to dry heat drawing at a draw ratio of 295% in a dry heat atmosphere at 105° C., and then were relaxed by 5% to obtain modacrylic fibers having a single fiber fineness of about 53.5 dtex and a strength of 1.44 cN/dtex. Regarding the obtained modacrylic fibers, the spinning time at 150 dtex was 30 seconds, the spinning time at 100 dtex was 0 seconds, and the minimum fineness was 150 dtex.

The strength of the modacrylic fibers, the spinning time at 150 dtex, the spinning time at 100 dtex, and the minimum fineness of the modacrylic fibers obtained in each of Examples 1 to 10 and Comparative Examples 1 to 6 were evaluated as described above, and results thereof were shown in Table 1 below. Note that “AN” described in Table 1 refers to the acrylonitrile.

TABLE 1

| | | | Ex. 1 | Ex. 2 | Ex. 3 | Ex. 4 | Ex. 5 | Ex. 6 | Ex. 7 | Ex. 8 |
|---|---|---|---|---|---|---|---|---|---|---|
| Thermoplastic | Macro- | Type | Production | Production | Production | Production | Production | Production | Production | Production |
| modacrylic | monomer | | Example 1 | Example 2 | Example 3 | Example 4 | Example 5 | Example 6 | Example 7 | Example 8 |
| resin | | Mn | 6000 | 6000 | 6000 | 6000 | 6000 | 6000 | 6000 | 6000 |
| | | Content of | 10 | 15 | 20 | 30 | 40 | 5 | 10 | 20 |
| | | AN(mol %) | | | | | | | | |
| | | Type | Random | Random | Random | Random | Random | Random | Random | Random |
| | | AN | Uniform | Uniform | Uniform | Uniform | Uniform | Uniform | Uniform | Uniform |
| | | introduction | | | | | | | | |
| | | site | | | | | | | | |

| | | | | | | | | | |
|---|---|---|---|---|---|---|---|---|---|
| | Content of AN(mass %) | 44.1 | 45.0 | 43.6 | 45.2 | 46.0 | 41.2 | 39.8 | 41.3 |
| | Mw | 47000 | 56600 | 45900 | 54900 | 47500 | 48100 | 43600 | 46500 |
| | Mw/Mn | 2.22 | 2.45 | 2.45 | 2.51 | 2.33 | 2.22 | 2.42 | 2.55 |
| | ηsp | 0.100 | 0.109 | 0.113 | 0.115 | 0.091 | 0.105 | 0.101 | 0.102 |
| Modacrylic | Undrawn yarn fibers | 150 | 150 | 150 | 125 | 150 | 150 | 150 | 150 |
| fiber | (dtex) | | | | | | | | |
| | Draw ratio | 270 | 270 | 270 | 200 | 270 | 295 | 295 | 295 |
| | (%) | | | | | | | | |
| | Strength | 1.70 | 2.00 | 1.78 | 1.50 | 1.51 | 1.58 | 1.52 | 1.58 |
| | (cN/dtex) | | | | | | | | |
| | Spinning time at | >180 | >180 | 120 | 90 | 30 | 60 | >300 | >300 |
| | 150 dtex (s) | | | | | | | | |
| | Spinning time at | >180 | 60 | 120 | <5 | 0 | 0 | >300 | >300 |
| | 100 dtex (s) | | | | | | | | |
| | Minimum fineness | 30 | 100 | 60 | 125 | 150 | 150 | 50 | 35 |
| | (dtex) | | | | | | | | |

| | | | | | Comp. | Comp. | Comp. |
|---|---|---|---|---|---|---|---|
| | | | Ex. 9 | Ex. 10 | Ex. 1 | Ex. 2 | Ex. 3 |
| Thermo- | Macro- | Type | Production | Production | Production | Production | Production |
| plastic | monomer | | Example 9 | Example 10 | Example 11 | Example 12 | Example 13 |
| modacrylic | | Mn | 6000 | 6000 | 6000 | 6000 | 6000 |
| resin | | Content of | 10 | 10 | — | 10 | 10 |
| | | AN(mol %) | | | | | |
| | | Type | Random | Random | — | α- | ω- |
| | | | | | | Block type | Block type |
| | | AN | Large | Large | — | Terminal | Non- |
| | | introduction | amount in | amount in | | region | terminal |
| | | site | terminal | non- | | | region |
| | | | region | terminal | | | |
| | | | | region | | | |

| | | | | | | |
|---|---|---|---|---|---|---|
| | Content of AN(mass %) | 42.6 | 42.4 | 43.5 | 43.7 | 43.4 |
| | Mw | 50200 | 53500 | 44200 | 46700 | 49800 |
| | Mw/Mn | 2.57 | 2.59 | 2.40 | 2.35 | 2.45 |
| | ηsp | 0.098 | 0.102 | 0.104 | 0.108 | 0.123 |
| Modacrylic | Undrawn yarn fibers | 150 | 150 | 150 | 150 | 125 |
| fiber | (dtex) | | | | | |
| | Draw ratio | 295 | 295 | 270 | 270 | 200 |
| | (%) | | | | | |
| | Strength | 1.68 | 2.03 | 1.23 | 1.78 | 1.29 |
| | (cN/dtex) | | | | | |
| | Spinning time at | 150 | >180 | 120 | 120 | 120 |
| | 150 dtex (s) | | | | | |
| | Spinning time at | 0 | 90 | 0 | 30 | 15 |
| | 100 dtex (s) | | | | | |
| | Minimum fineness | 125 | 80 | 125 | 100 | 100 |
| | (dtex | | | | | |

| | | | Comp. | Comp. | Comp. |
|---|---|---|---|---|---|
| | | | Ex. 4 | Ex. 5 | Ex. 6 |
| Thermo- | Macro- | Type | Production | Production | Production |
| plastic | monomer | | Example 14 | Example 15 | Example 16 |
| modacrylic | | Mn | 6000 | 6000 | 6000 |
| resin | | Content of | 20 | 20 | — |
| | | AN(mol %) | | | |
| | | Type | α- | ω- | — |
| | | | Block type | Block type | |
| | | AN | Terminal | Non- | — |
| | | introduction | region | terminal | |
| | | site | | region | |

| | | | | |
|---|---|---|---|---|
| | Content of AN(mass %) | 44.6 | 43.2 | 41.0 |
| | Mw | 50900 | 43700 | 47600 |
| | Mw/Mn | 2.43 | 2.37 | 2.49 |
| | ηsp | 0.104 | 0.085 | 0.111 |
| Modacrylic | Undrawn yarn fibers | 150 | 150 | 150 |
| fiber | (dtex) | | | |
| | Draw ratio | 270 | 270 | 295 |
| | (%) | | | |
| | Strength | 1.76 | 1.39 | 1.44 |
| | (cN/dtex) | | | |
| | Spinning time at | 10 | >180 | 30 |
| | 150 dtex (s) | | | |
| | Spinning time at | 0 | 60 | 0 |
| | 100 dtex (s) | | | |
| | Minimum fineness | 150 | 75 | 150 |
| | (dtex | | | |

It was found from the results in Table 1 that as compared with the thermoplastic modacrylic resin of Comparative Example 1 in which no acrylonitrile was introduced into the macromonomer,
(1) the strength and the stability for melt spinning were high in the thermoplastic modacrylic resins of Examples 1 to 3 in which 10 mol %, 15 mol %, or 20 mol % of the acrylonitrile with respect to all the constituent units of the macromonomer was randomly introduced into the macromonomer,
(2) the strength was high in the thermoplastic modacrylic resins of Examples 4 and 5 in which 30 mol % or 40 mol % of the acrylonitrile with respect to all the constituent units of the macromonomer was randomly introduced into the macromonomer.
   It was found from the results in Table 1 that as compared with the thermoplastic modacrylic resin of Comparative Example 6 in which no acrylonitrile was introduced into the macromonomer,
(1) the strength and the stability for melt spinning were high in the thermoplastic modacrylic resins of Examples 7 to 10 in which 10 mol % and more of the acrylonitrile with respect to all the constituent units of the macromonomer was randomly introduced into the macromonomer,
(2) the strength was high in the thermoplastic modacrylic resin of Example 6 in which 5 mol % of the acrylonitrile with respect to all the constituent units of the macromonomer was randomly introduced into the macromonomer. It was found from the results in Table 1 that as compared with the thermoplastic modacrylic resins of Comparative Examples 2 and 4 in which the acrylonitrile was introduced into the terminal region of the macromonomer in the macromonomer,
   the stability for melt spinning was high in the thermoplastic modacrylic resins of Examples 1 to 3 in which 10 mol %, 15 mol %, or 20 mol % of the acrylonitrile with respect to all the constituent units of the macromonomer was randomly introduced into the macromonomer,
   it was found from the results in Table 1 that as compared with the thermoplastic modacrylic resins of Comparative Examples 3 and 5 in which the acrylonitrile was introduced into the non-terminal region of the macromonomer in the macromonomer, the strength was high in the thermoplastic modacrylic resins of Examples 1 to 5 in which 10 mol % or more of the acrylonitrile with respect to all the constituent units of the macromonomer was randomly introduced into the macromonomer. Based on these experimental results, it is possible to randomly introduce the acrylonitrile into the macromonomer and impart properties such as improvement of either or both of strength and stability for melt spinning depending on an amount of the acrylonitrile introduced.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A thermoplastic modacrylic resin comprising a copolymer, the copolymer containing:
a polymer (A) formed of a modacrylic resin containing a constituent unit derived from acrylonitrile (a1) and a constituent unit derived from an ethylenically unsaturated monomer (a2) other than the acrylonitrile (a1), and
a polymer (B) composed of a polymer containing a constituent unit derived from acrylonitrile (b1) and a constituent unit derived from an ethylenically unsaturated monomer (b2) other than the acrylonitrile (b1),
wherein:
the polymer (B) has a first terminal and a second terminal, and is bonded to the polymer (A) at the second terminal,
the polymer (B) contains more than 30 mol % and less than 70 mol % of all constituent units derived from the acrylonitrile (b1) in a terminal region including the first terminal and including half of the number of all constituent units in the polymer (B),
a content of the constituent unit derived from the acrylonitrile (b1) is 3 mol % or more and 50 mol % or less with respect to all the constituent units in the polymer (B),
in the thermoplastic modacrylic resin, a content of the constituent unit derived from the acrylonitrile (a1) is 35 mass % or more and 84.5 mass % or less, a content of the constituent unit derived from the ethylenically unsaturated monomer (a2) is 15 mass % or more and 64.5 mass % or less, and a content of the polymer (B) is 0.5 mass % or more and 40 mass % or less.

2. The thermoplastic modacrylic resin according to claim 1, wherein the ethylenically unsaturated monomer (a2) is at least one selected from the group consisting of a vinyl halide, a vinylidene halide, and vinyl acetate.

3. The thermoplastic modacrylic resin according to claim 1, wherein the ethylenically unsaturated monomer (b2) is at least one selected from the group consisting of a (meth)acrylate-based monomer, a styrene-based monomer, a nitrile group-containing vinyl monomer, and an amide group-containing vinyl monomer.

4. The thermoplastic modacrylic resin according to claim 1, wherein the polymer (B) has a number average molecular weight of 1000 or more and 50000 or less.

5. A thermoplastic modacrylic resin composition, comprising:
the thermoplastic modacrylic resin according to claim 1; and
a plasticizer,
wherein the plasticizer is an organic compound having compatibility with the thermoplastic modacrylic resin and having a boiling point of 200° C. or higher.

6. The thermoplastic modacrylic resin composition according to claim 5, wherein a content of the plasticizer is 0.1 parts by mass or more and 50 parts by mass or less with respect to 100 parts by mass of the thermoplastic modacrylic resin.

7. The thermoplastic modacrylic resin composition according to claim 5, wherein the plasticizer is at least one selected from the group consisting of dimethyl sulfone, diethyl sulfone, dipropyl sulfone, dibutyl sulfone, diphenyl sulfone, vinyl sulfone, ethyl methyl sulfone, methyl phenyl sulfone, methyl vinyl sulfone, 3-methylsulfolane, dipropyl sulfoxide, tetramethylene sulfoxide, diisopropyl sulfoxide, methyl phenyl sulfoxide, dibutyl sulfoxide, diisobutyl sulfoxide, di-p-tolyl sulfoxide, diphenyl sulfoxide, benzyl sulfoxide, lactic acid lactide, pyrrolidone, N-methylpyrrolidone, N-vinylpyrrolidone, ε-caprolactam, N-methylcaprolactam, γ-butyrolactone, γ-hexalactone, γ-heptalactone, γ-octalactone, ε-caprolactone, and ε-octalactone.

8. The thermoplastic modacrylic resin composition according to claim 5, wherein the plasticizer is at least one selected from the group consisting of dimethyl sulfone and lactic acid lactide.

9. The thermoplastic modacrylic resin composition according to claim 5, further comprising: at least one stabilizer selected from the group consisting of an epoxy-based heat stabilizer, a hydrotalcite-based heat stabilizer, a tin-based heat stabilizer, a Ca—Zn-based heat stabilizer, and a β-diketone-based heat stabilizer.

10. The thermoplastic modacrylic resin composition according to claim 9, wherein a content of the stabilizer is 0.1 parts by mass or more and 30 parts by mass or less with respect to 100 parts by mass of the thermoplastic modacrylic resin.

11. The thermoplastic modacrylic resin composition according to claim 9, wherein the stabilizer is at least one selected from the group consisting of polyglycidyl methacrylate, tetrabromobisphenol A diglycidyl ether, hydrotalcite, zinc 12-hydroxystearate, calcium 12-hydroxystearate, stearoyl benzoyl methane (SBM), and dibenzoyl methane (DBM).

12. A molded product formed of the thermoplastic modacrylic resin composition according to claim 5.

13. A modacrylic fiber formed of the thermoplastic modacrylic resin composition according to claim 5.

14. A method for producing a modacrylic fiber, comprising melt-spinning the thermoplastic modacrylic resin composition according to claim 5 to obtain a modacrylic fiber.
